(19) United States
(12) Patent Application Publication
(10) Pub. No.: US 2003/0154462 A1
(43) Pub. Date: Aug. 14, 2003

(54) Software maintenance material generation apparatus and generation program therefor

(75) Inventor: Yoshitomo Kumagai, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/216,785

(22) Filed: Aug. 13, 2002

(30) Foreign Application Priority Data
Feb. 13, 2002 (JP) 2002-036058

(51) Int. Cl. G06F 9/44

(52) U.S. Cl. 717/120; 717/123

(57) ABSTRACT

An apparatus including a unit for analyzing the relation among a plurality of modules of software from one or more objects forming the software, a unit for storing the analysis unit, a unit for displaying the analysis result as a module link structure diagram, and a unit for receiving from a user an instruction to change a display style of the displayed module link structure diagram, and controlling the change of the display style correctly grasps the current contents from the software to which functions, etc. are added at the using stage.

### BACKGROUND OF THE INVENTION

1. Field of the Invention

The present invention relates to a software, that is, a program maintenance system, and more specifically to a software maintenance material generation apparatus for more correctly grasping the current contents of the program whose function has been improved when it is used after development or to which a new function has been added.

2. Description of the Related Art

FIG. 1 is a flowchart of the conventional development of a program. Generally, in developing a program, a basic plan, a detailed plan, a module plan, specifications for each plan, etc. are generated, and then actual programming steps are performed.

When a program is completed, a test is conducted on the completed program. If there is any problem, the program is amended, and the amended program is provided for the users.

However, in the process of actual operations of the program on the user sides, the program is amended for addition of new functions, improvement of existing functions, etc. The amended program source is different from the specifications, etc. corresponding to, for example, a module plan. Especially, it is quite different from the specifications corresponding to a basic plan.

That is, an amendment made before providing the program for the users is normally carried out to correctly reflect the specifications. However, after completion of the program, the functions are improved or new functions are added, it is not always necessary to amend the specifications, and the operations of the program can be performed without the maintenance of the specifications, thereby often leaving alone the time and labor consuming correction of the specifications.

As a result, when a third party different from the developer takes over the maintenance of the program, the original specifications are often left alone. Although the maintainer tries to grasp the contents of the program and improve the program by adding new functions, there are no documents used by the maintainer correctly grasping the current program, thereby consuming a long time and a high cost in analyzing the current program.

To add new functions to a program, largely change the program, and efficiently take over the program to a third party, various materials such as specifications, etc. are required to grasp the program in detail. Then, the technology of generating the specifications from the source code of the program is required. The conventional technology includes the following materials.

Document 1: Japanese Patent Application Laid-Open No. Hei-7-234783 “Document Information Extracting System in Automatic Document Generation System”

Document 2: Japanese Patent Application Laid-Open No. Hei-8-286898 “System Analysis Apparatus”

Document 1 discloses a document information extracting system capable of outputting the correct contents of a document by a simple operation although the position of the description of the comment which is the information about the document is not in accordance with the rules of the system when the document is inversely generated from the source program described in the C language.

Document 2 discloses a system analysis apparatus which generates and outputs as analysis documents: a menu development diagram in which the call relation among programs is displayed on a tree by analyzing the object code and the source code of a system; a list of CL programs showing the number of steps, object sizes, etc. about all CL programs; a diagram of a job structure showing the structure of each CL program on a flowchart; etc.

However, in the above mentioned conventional technology, there has been the problem that the contents of the program cannot be analyzed in detail by generating a diagram of the structure of a module link showing the detailed configuration of the program, that is, a diagram of the structure of the link among a plurality of modules forming the program; the specifications of a table in a file from the header file; and a list of the tables based on which the specifications are generated.

First, when a diagram of the structure of a module link is generated from a source code, it is necessary to insert a tag into the source code in advance on a predetermined condition, and generating the source code is a troublesome process. Furthermore, since different languages such as the C language, FORTRAN language, etc. are used for a source code, the process is to be performed depending on the language, thereby complicating the entire process.

In the technology of generating a diagram of the structure of a module link from an object, a command of a generally marketed OS is executed as described in Document 2 above. Therefore, it cannot be applied to any different OS.

In addition, although a diagram of the structure of a module link is generated using such a command, a program having a complicated structure of a module link may output a result on several separate sheets, or cannot output a diagram of the structure based on a point to be analyzed, thereby tracing a troublesome analyzing process. That is, most existing systems aim at generating specifications, but have no applications for processing and editing the specifications for improvement.

The technology of generating table specifications and table lists from a header file can be realized by the conventional technology of generating a table of a variable name, type, size, and comment. However, the conventional technology cannot represent table specifications in a diagram of a structure, or display an offset, thereby requiring a considerable time and effort to grasp the value of each variable when a memory dump is obtained. Furthermore, since there is no link between the generated table specifications, a troublesome operation is required when a process is performed by sequentially tracing the tables.

### SUMMARY OF THE INVENTION

The present invention has been developed to solve the above mentioned problems, and aims at providing a software maintenance material generation apparatus and a generation program therefor so that a diagram of the structure of the link among a plurality of modules forming a program, which can be easily processed and edited by a user, can be generated from an object module independent of a language, a diagram of the structure of each table can be generated from a header file, and a link can be established between the diagrams of the structures of tables.

To attain the above mentioned object and generate the maintenance material of software including a plurality of modules as components, the software maintenance material generation apparatus according to the present invention includes: a link relation analysis unit for analyzing the link relation among the plurality of modules from one or more objects corresponding to the software; and a link relation storage unit for storing an analysis result of the link relation analysis unit.

To generate a software maintenance material including the contents of one or more header files as components, the software maintenance material generation apparatus according to the present invention further includes a table specification generation unit for generating the specifications of each table in the file from the one or more header files.

Additionally, to attain the above mentioned object and for use by a computer for generating the maintenance material of software formed by a plurality of modules, the program according to the present invention includes a procedure of analyzing the link relation among the plurality of modules from one or more objects corresponding to the software; and a procedure of storing an analysis result of the link relation in the memory.

For use by a computer generating the maintenance material of software including the contents of one or more header files as components, the program according to the present invention includes a procedure of generating the specifications of each table in the file from the one or more header files; and a procedure of generating a list of tables for each of which the table specifications are generated.

### BRIEF DESCRIPTION OF THE DRAWINGS

FIG. 1 is a conventional flow of developing a program;

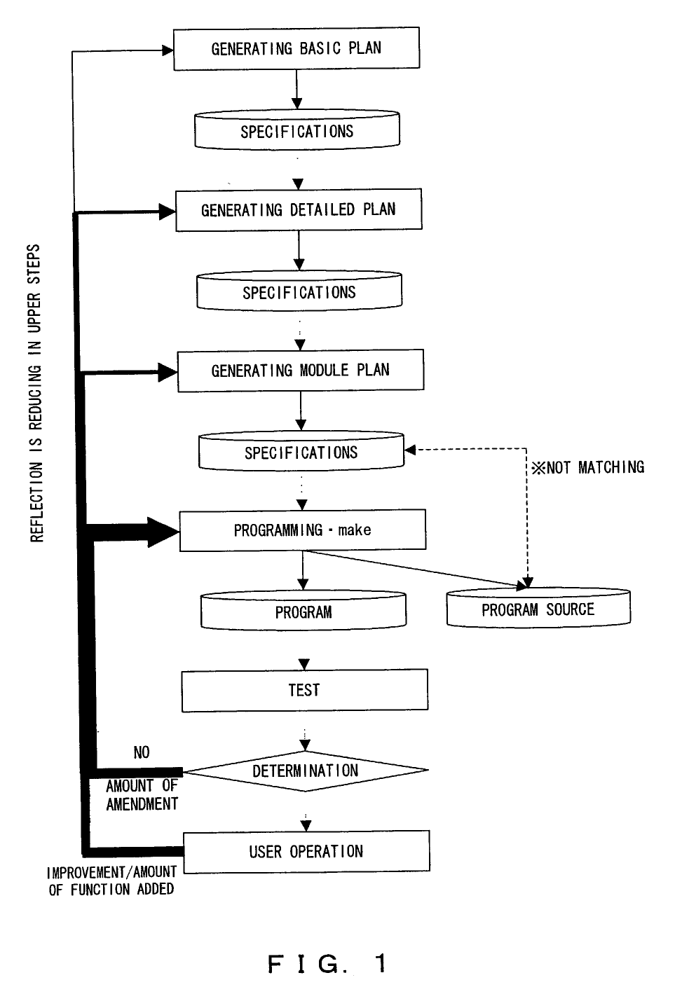

FIG. 2A is a block diagram showing the configuration of the principle of the software maintenance material generation apparatus according to the present invention;

FIG. 2B is a block diagram showing the configuration of a module link structure analysis device according to an embodiment of the present invention;

FIG. 3 shows the configuration of the program from a source file and an object module;

FIG. 4 is a flowchart of the process of generating a module link table from an object;

FIG. 5 is a flowchart (continued) of the process of generating a module link table from an object;

FIG. 6 is a flowchart (continued from above) of the process of generating a module link table from an object;

FIG. 7 shows an example of a format of storing a module link table;

FIG. 8 shows an example of the contents of the dump list shown in FIG. 4;

FIG. 9 shows an example of the contents of the work table shown in FIG. 4;

FIG. 10 shows an example (1) of the contents of the dump list shown in FIG. 5;

FIG. 11 shows an example (2) of the contents of the dump list shown in FIG. 5;

FIG. 12 shows an example of a table generated according to the symbol information shown in FIG. 10;

FIG. 13 shows an example (1) of the contents of the dump list shown in FIG. 6;

FIG. 14 shows an example (2) of the contents of the dump list shown in FIG. 6;

FIG. 15 shows an example of the contents of the work table shown in FIG. 6;

FIG. 16 shows an example of a module link structure;

FIG. 17 shows an example of the tree representation of a module link structure;

FIG. 18 is a flowchart of the entire process of displaying a module link structure diagram;

FIG. 19 is a flowchart of the process of displaying a module link structure;

FIG. 20 is a flowchart of the process of displaying an individual module;

FIG. 21 shows an example of displaying a module link structure diagram;

FIG. 22 is an enlarged diagram of an example of the display shown in FIG. 21;

FIG. 23 is a flowchart of the process of displaying a pop-up menu;

FIG. 24 shows an example of a module link structure diagram being developed and displayed;

FIG. 25 shows an example of a module link structure diagram being displayed as closed;

FIG. 26 shows an example (1) of using a pop-up menu;

FIG. 27 shows an example (2) of using a pop-up menu;

FIG. 28 shows an example (1) of displaying a screen when a cut (top) button is selected;

FIG. 29 shows an example (2) of displaying a screen when a cut (top) button is selected;

FIG. 30 shows the format of a control table of a module link structure diagram;

FIG. 31 is a flowchart of the process when a cut (top) button is selected;

FIG. 32 is a flowchart of the process of generating a link state table to an upper module;

FIG. 33 shows an example of a link state table to an upper module;

FIG. 34 is a flowchart of the process of obtaining the height of each module;

FIG. 35 is an example of the process of obtaining the height of a rectangle;

FIG. 36 shows an example of a result of the drawing position determining operation with the height of each module;

FIG. 37 shows the method of determining a rectangle drawing position on the display screen;

FIG. 38 shows an example of a module link structure when a cut (middle) is selected;

FIG. 39 shows an example of displaying a link structure diagram when a cut (middle) is selected;

FIG. 40 shows an example of the contents stored in an exclusion module indicative file;

FIG. 41 shows an example of a control list menu;

FIG. 42 is a flowchart of the exclusion process using a control list menu;

FIG. 43 is a flowchart of the process of printing a module link structure diagram;

FIG. 44 shows selecting a button when a link structure diagram is printed;

FIG. 45 shows an example of printing a module link structure diagram;

FIG. 46 shows an example of an HTML file of a module link structure diagram;

FIG. 47 is a flowchart of the process of generating an HTML document of a module link structure diagram;

FIG. 48 is a flowchart of the process of generating function input/output specifications from a source file;

FIG. 49 shows an example of displaying a link structure diagram generated as an HTML document;

FIG. 50 shows an example of displaying another HTML document traced using a link tag;

FIG. 51 shows an example of displaying the contents of the source file traced from the rectangle shown in FIG. 49;

FIG. 52 shows an example of displaying a source file traced from the module name shown in FIG. 49;

FIG. 53 is a block diagram of the configuration of the table structure analysis device for generating internal table specifications, etc. from the header file;

FIG. 54 is a flowchart of the entire process from the header file to generating a table list;

FIG. 55 is a detailed flowchart of the process of generating a table structure diagram shown in FIG. 54;

FIG. 56 shows an example of the contents of the header file;

FIG. 57 shows an example of an HTML document indicative of the table structure diagram generated from the header file shown in FIG. 56;

FIG. 58 shows an example of displaying the HTML document shown in FIG. 57;

FIG. 59 shows an example of an HTML document indicative of a table list;

FIG. 60 shows an example of displaying the HTML document shown in FIG. 59;

FIG. 61 shows an example of displaying a specific keyword in the header file;

FIG. 62 shows an example of an HTML document indicative of a table structure diagram;

FIG. 63 shows an example of displaying a table traced from the document shown in FIG. 62;

FIG. 64 shows an example of displaying the HTML document into which a link to another table is inserted; and

FIG. 65 is an explanatory diagram of loading a program for realizing the present invention into a computer.

### DESCRIPTION OF THE PREFERRED EMBODIMENTS

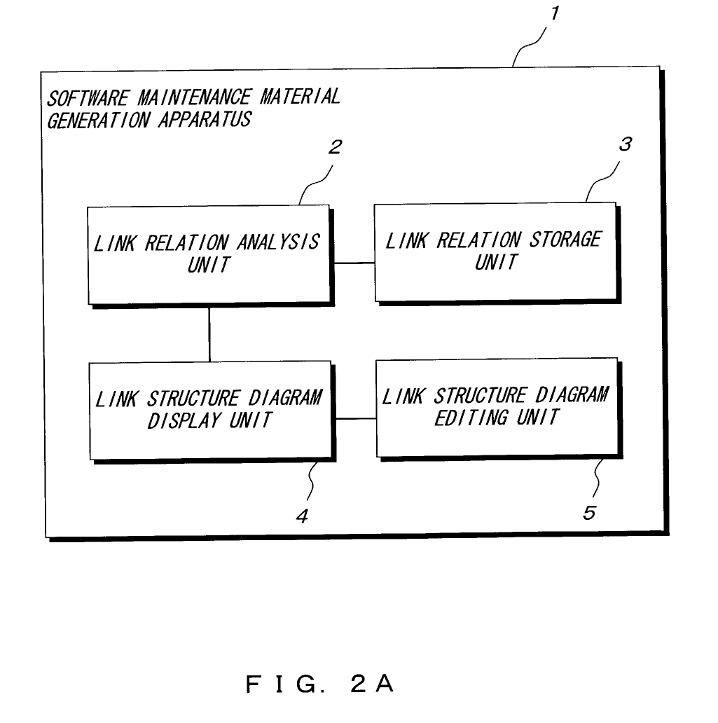

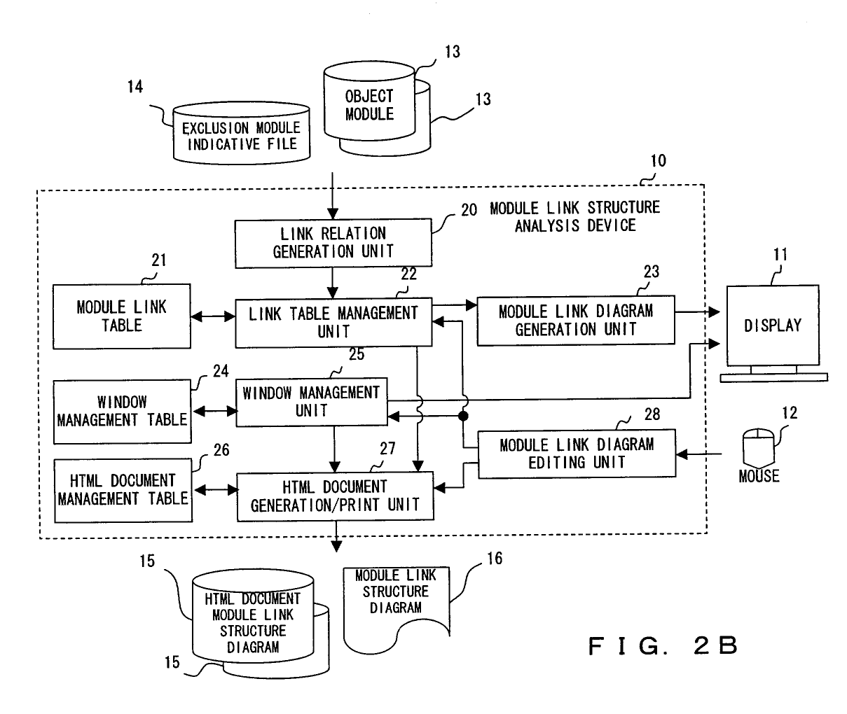

FIG. 2A is a block diagram showing the configuration of the principle of the software maintenance material generation apparatus according to the present invention. FIG. 2A shows the configuration of a software maintenance material generation apparatus 1 for generating a software maintenance material formed by a plurality of modules. The apparatus 1 comprises at least a link relation analysis unit 2, and a link relation storage unit 3.

The link relation analysis unit 2 analyzes the link relation among the plurality of modules from one or more objects corresponding to software, and the link relation storage unit 3 stores an analysis result of the link relation analysis unit 2.

In an embodiment of the present invention, the software maintenance material generation apparatus 1 can also comprise a link structure diagram display unit 4 for displaying the analysis result of the link relation analysis unit 2 as a module link structure diagram, and a link structure diagram editing unit 5 for receiving an instruction to change a display style for the displayed module link structure from an external unit, and controls the change of the display style.

In this case, the link structure diagram editing unit 5 can control the display style change into a module link structure diagram in which a module externally indicated can be set at the leading portion, the trailing portion, or around the center on the display screen in the displayed module link structure diagram, and can also control the display style change to display or not to display a module lower than the specified module.

Furthermore, according to an embodiment of the present invention, the software maintenance material generation apparatus can further comprise a document generation unit for generating a document corresponding to the displayed module link structure diagram, for example, an HTML document. The document generation unit can insert into the module in the structure diagram a link specifying the directory of the source file of the program, for example, a WWW link, and a WWW link specifying a different module link structure diagram.

Additionally, according to an embodiment of the present invention, the software maintenance material generation apparatus further comprises a specification generation unit for generating module specifications in, for example, an HTML format, from a source file, to allow the document generation unit to insert a link, for example, a WWW link, into the module specifications corresponding to a specific keyword in the document.

According to the present invention, the apparatus for generating a software maintenance material including the contents of one or more header file as a component comprises a table specification generation unit for generating the specifications of each of the internal tables from one or more header files in, for example, an HTML format.

According to an embodiment of the present invention, the software maintenance material generation apparatus can further comprise a table list generation unit for generating a table list whose specifications have been generated in, for example, an HTML format. The table list generation unit can insert a link into a document in the HTML format in the table list to display a specified table when a specific table is externally specified after displaying the table list through, for example, a WWW browser.

Furthermore, according to the software maintenance material generation apparatus, the table specification generation unit can insert a link to another table into an internal table when there is a pointer in the internal table to the other table, and also can insert a link to the header file into the table specifications.

The software maintenance material generating program according to the present invention is used to direct a computer to perform the process of analyzing the link relation among a plurality of modules from one or more objects corresponding to the software, and the process of storing the analysis result in the memory. In the embodiment, a portable computer-readable storage medium storing the program is used.

In addition, the software maintenance material generating program according to the present invention is used to direct a computer to perform the process of generating the specifications of each of the internal tables in, for example, an HTML format from one or more header files, and the process of generating a table list whose specifications have been generated in, for example, the HTML format. In the embodiment, a portable computer-readable storage medium storing the program is used.

As described above, according to the present invention, the link relation among a plurality of modules, which are the components of the software, is analyzed from one or more object programs corresponding to the software, the module link structure diagram indicating the relation is displayed, and the display style of the link structure diagram is changed at, for example, an instruction of a user, thereby analyzing the software.

FIG. 2B is a block diagram of the configuration of the module link structure analysis device according to an embodiment of the present invention. A display 11 for displaying a module link structure diagram, etc. and a mouse 12 for operations by a user are connected to a module link structure analysis device 10. As the input into the device 10, a plurality of object modules 13 and an exclusion module indicative file 14 are normally provided. The exclusion module indicative file is described later.

A module link structure diagram and an HTML document 15 are output as a plurality of files and a module link structure diagram 16 is output as printout as the output from the device 10.

The module link structure analysis device 10 comprises a link relation generation unit 20 for generating the link relation among modules corresponding to the input of the object module 13, etc.; a link table management unit 22 for receiving the output of the link relation generation unit 20 and managing a module link table 21, etc.; a module link diagram generation unit 23 for generating a module link structure diagram in response to the data from the link table management unit 22; a window management unit 25 for managing a window management table 24; an HTML document generation/print unit 27 for generating an HTML document stored in an HTML document management table 26 using the data from the link table management unit 22; and a module link diagram editing unit 28 for editing a module link diagram corresponding to a user instruction, etc. through the mouse 12.

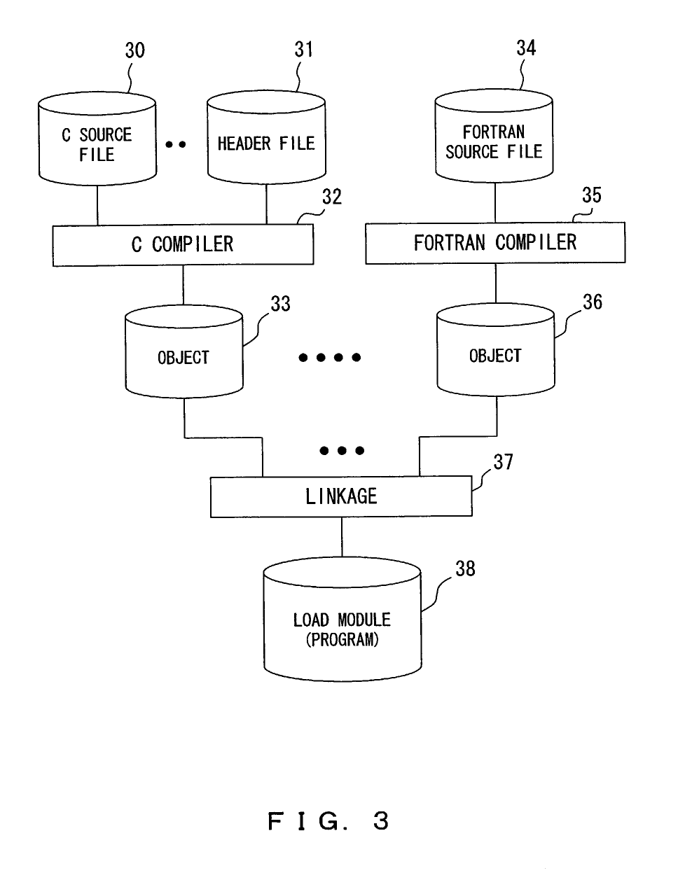

FIG. 3 shows the common configuration of the program from plurality of source files and a plurality of object (modules). In FIG. 3, for example, an object (module) 33 is generated by a compiler 32 in the C language from a source file 30 in, for example, the C language, and a header file 31. Furthermore, an object (module) 36 is generated by a FORTRAN compiler 35 from a source file 34 in, for example, the FORTRAN language.

The object (module) 33 and the object (module) 36 are language independent modules. These object modules are linked by a linkage (program) 37, and a load module, that is, a program 38, is generated.

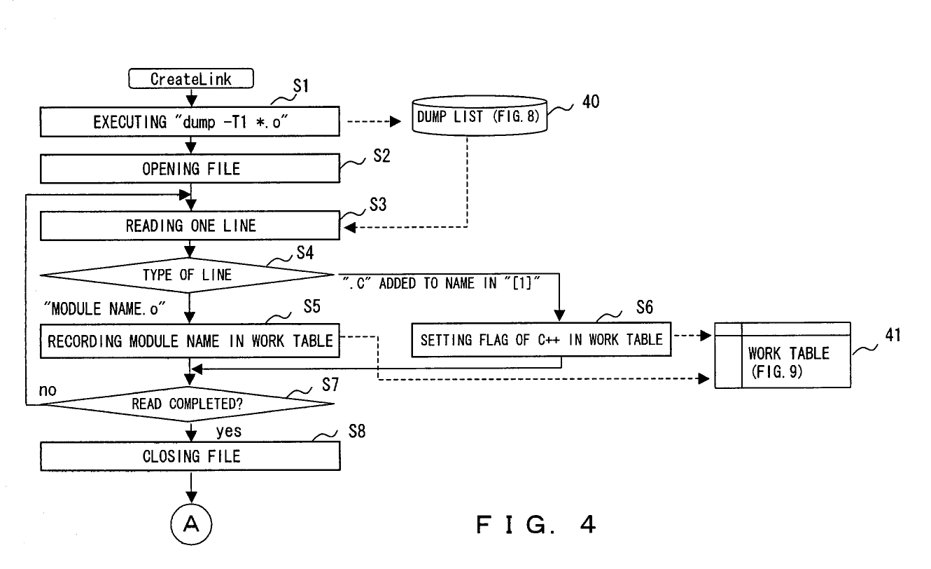

According to an embodiment of the present invention, a link structure diagram of a module in each source file is generated from the plurality of object (module) 33, . . . , 36 shown in FIG. 3, a generated module link structure diagram is displayed on the display screen of the display 11 shown in FIG. 2B, and the module link structure diagram is processed by the user operating the mouse 12. FIGS. 4 through 6 are detailed flowcharts of the process of generating a module link table showing the structure of the link between the modules from the object.

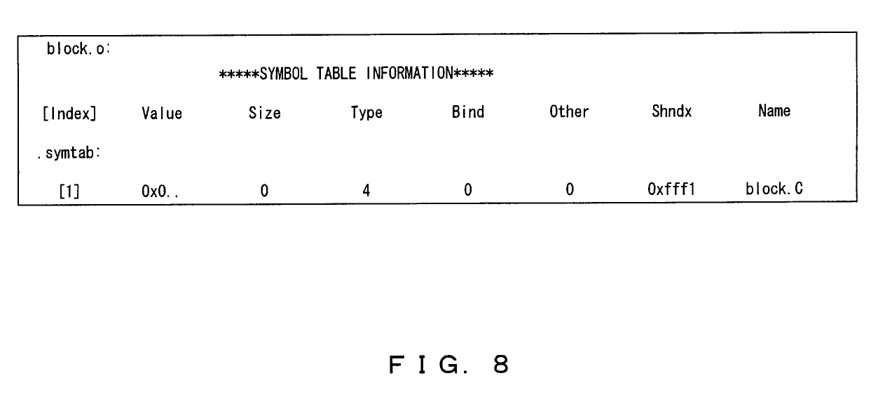

In FIG. 4, a process corresponding to all objects is performed. First, in step S1, a dump command to read the contents of all objects is executed, and a dump list 40 is generated. The contents of the dump list are described later by referring to FIG. 8. In step S2, the file of the dump list 40 is opened, and one line of the contents of the file is read in step S3.

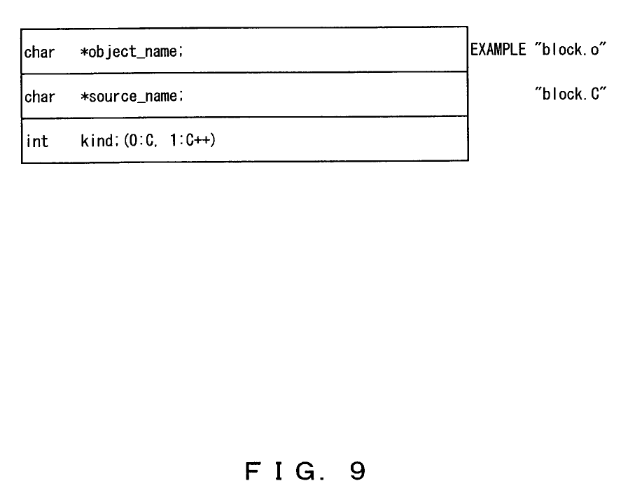

If the type of the read line is determined in step S4, and is “module name.O”, then the module name is recorded in a work table 41 in step S5. If the type of the line is [1] for index, and the name is followed by “.C”, then a flag of C++ is set in the work table 41 in step S6, and it is determined in step S7 whether or not the read has been completed. If the read has not been completed, then the process in step S3 of reading the stored file line by line is repeated. When the read is completed, the file is closed in step S8. The contents of the work table 41 are described later by referring to FIG. 9.

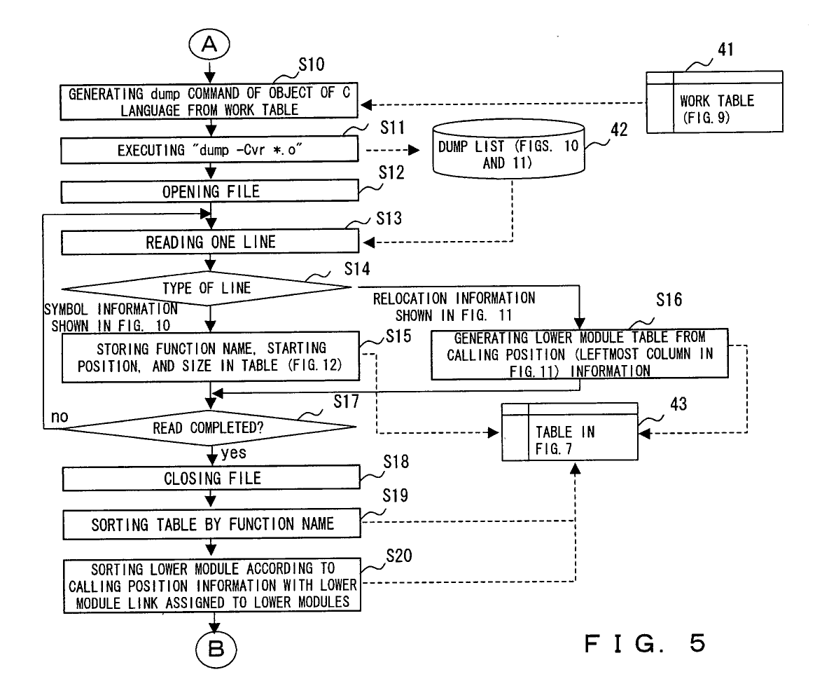

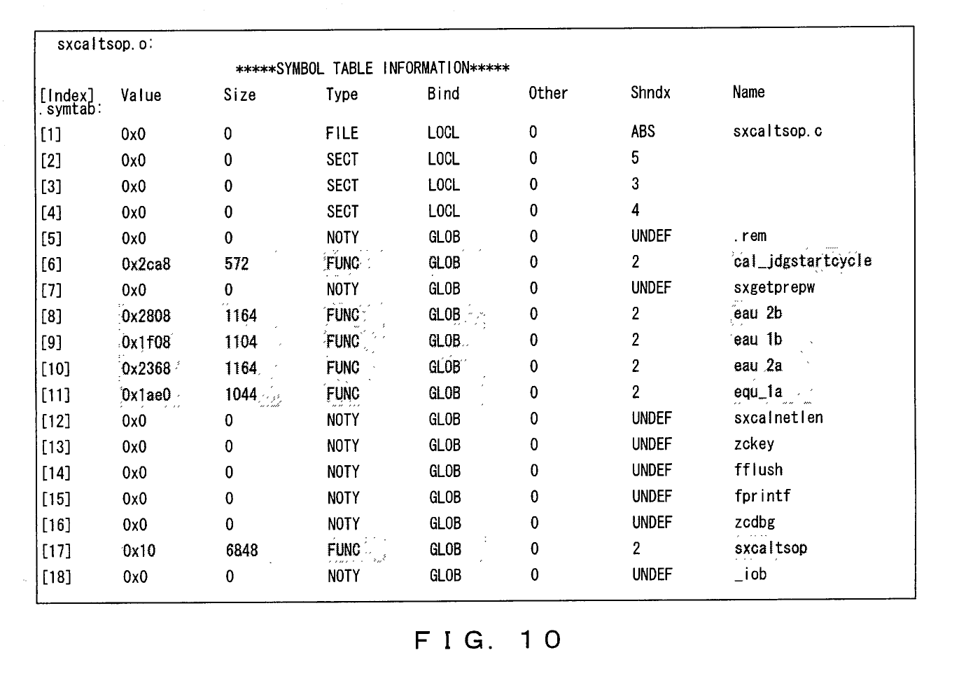

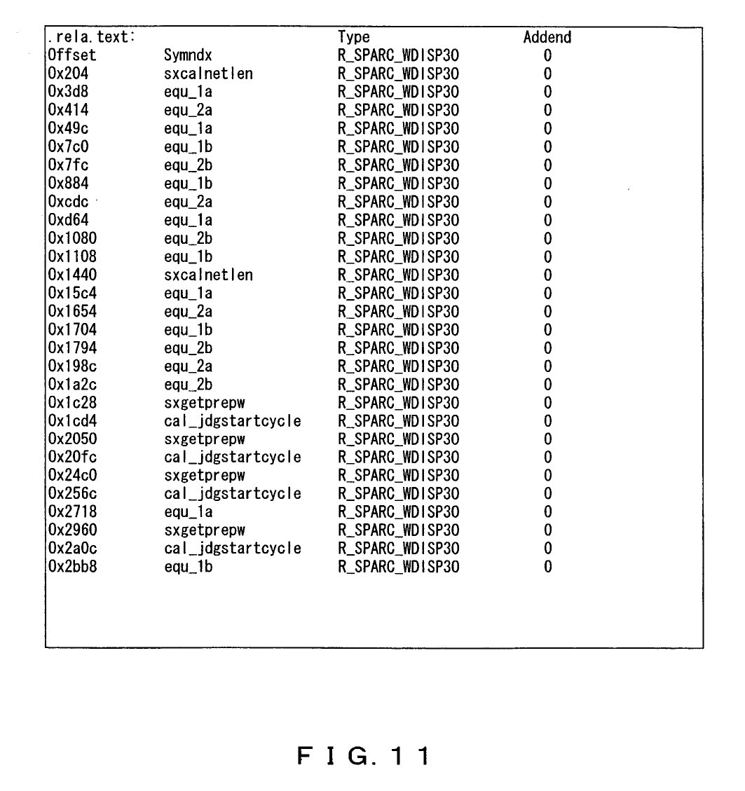

FIG. 5 shows the process of the object corresponding to the C language source file. According to the present embodiment, unlike the process in FIG. 3, it is assumed that the source file is described in the C language or the C++ language. First, in step S10, a dump command for the object of the C language source file is generated corresponding to the contents of the work table 41, and the dump command is executed and a dump list 42 is generated in step S11. The work table 41 shown in FIG. 4 is assumed to have been generated for the number of objects. The contents of the dump list 42 are described later in FIGS. 10 and 11.

In step S12, the file in the dump list 42 is opened, one line of the file is read in step S13, and the type of the line is determined in step S14. If the type of line is symbol information described by referring to FIG. 10, then after storing the function name as a module, the function starting position, and the function size in a table 43 in step S15, it is determined in step S17 whether or not the file has been completely read, and the processes in and after step S13 are repeated if it has not been completely read. If the type of line is relocation information described by referring to FIG. 11, then after setting in the table 43 the data of a lower module link according to the information about the function calling position in step S16, it is determined in step S17 whether or not the file has been completely read, and the processes in and after step S13 are repeated if it has not been completely read.

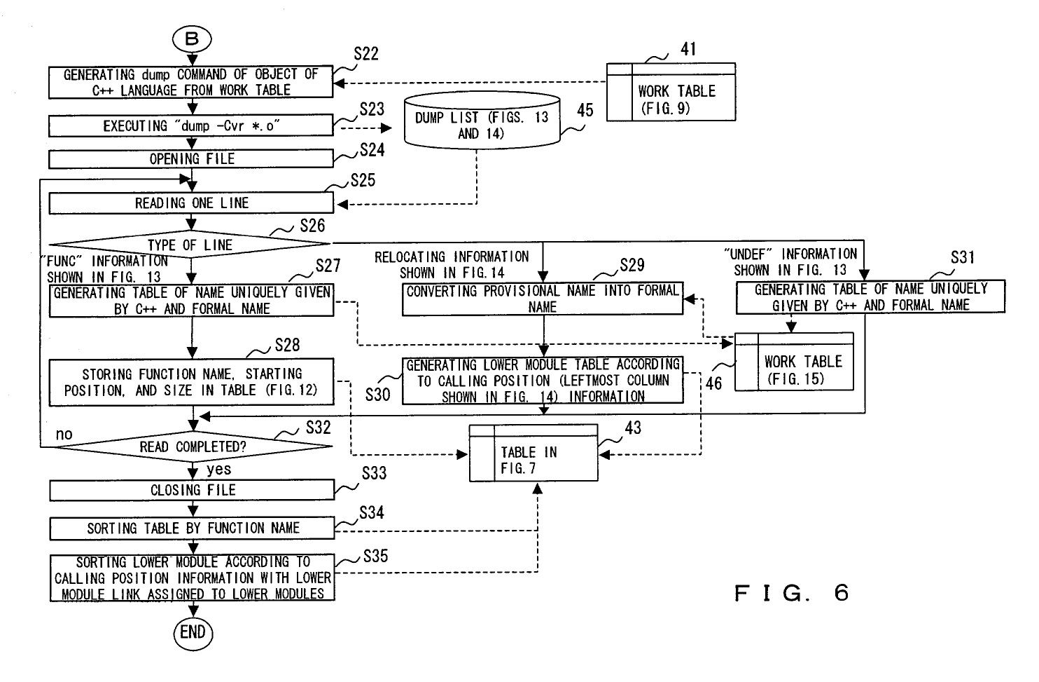

If the read of the file has been completed, the file is closed in step S18, the contents of the table 43 are sorted using the function name (module name) in step S19, the lower module is sorted according to the calling position information and a lower module link is assigned in the table 43 in step S20, and control is passed to the process shown in FIG. 6.

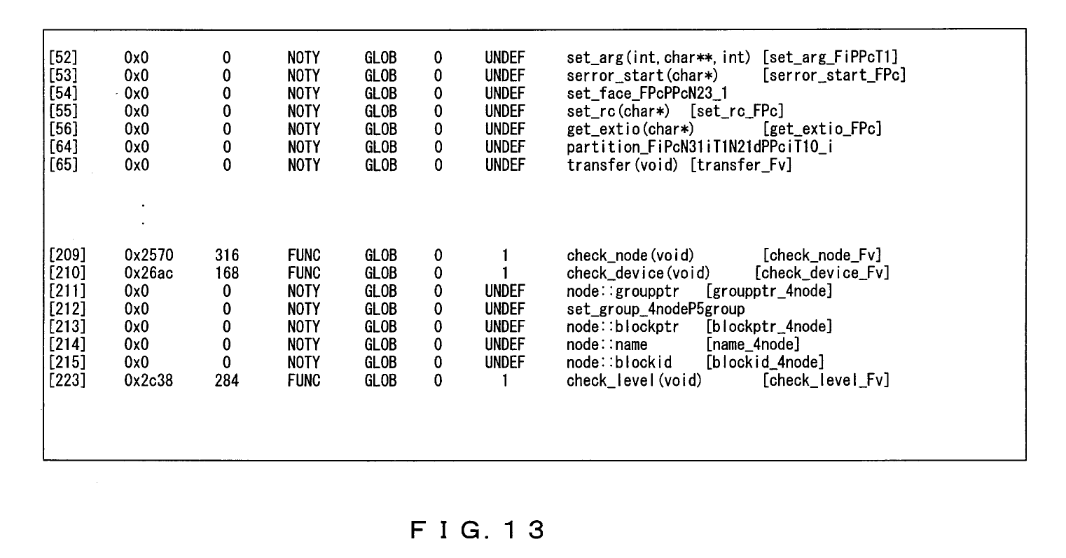

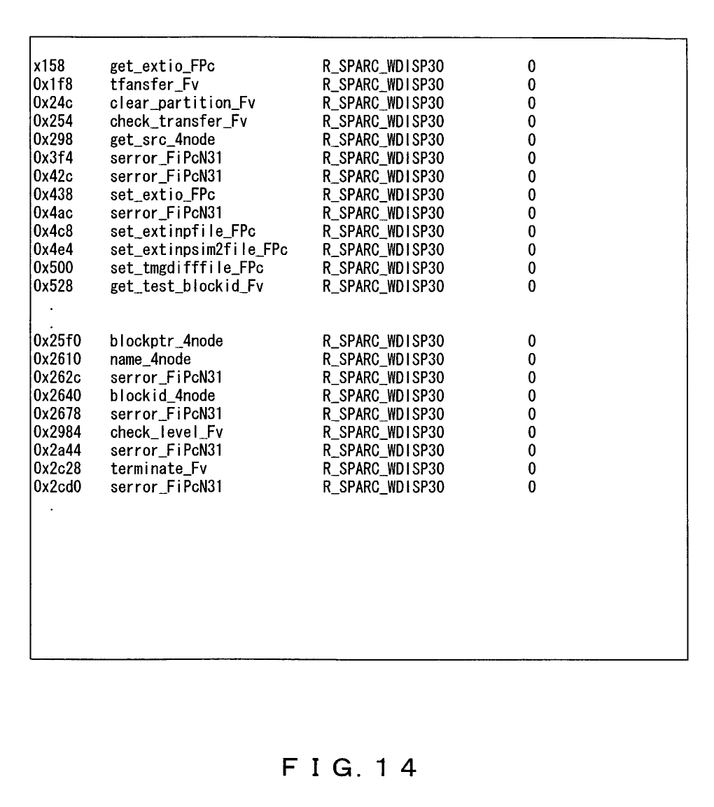

FIG. 6 shows the process of an object corresponding to the C++ language source file. First, in step S22, a dump command of an object corresponding to the C++ language is generated from the contents of the work table 41 shown in FIG. 4, the command is executed in step S23, and a dump list 45 is generated. The contents of the dump list 45 are described later by referring to FIGS. 13 and 14.

In step S24, the file in the dump list 45 is opened, one line of the file is read in step S25, and the type of the line is determined in step S26.

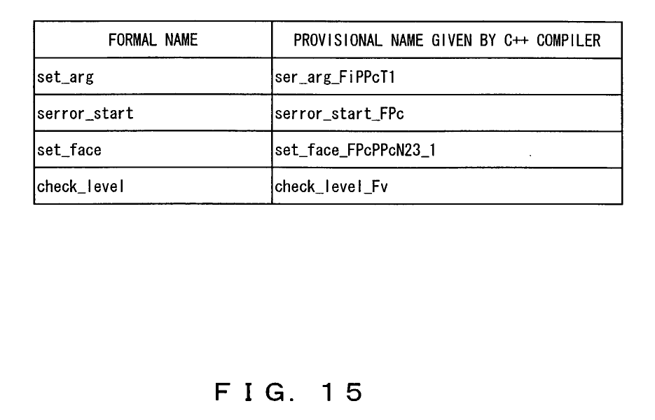

If the type of the line is “FUNC” information described by referring to FIG. 13, then after generating a work table 46 (shown in FIG. 15) for correspondence between a provisional name given by the C++ compiler and the formal name in step S27, the table 43 stores the function name, starting position, and size in step S28, and it is determined in step S32 whether or not the read of the file has been completed. If it has not been completed, then the processes in and after step S25 are repeated.

If the type of the line is relocation information described by referring to FIG. 14 in step S26, then the provisional name given by the C++ compiler is converted into the formal name using the contents of the work table 46 in step S29, the data of the lower module link is generated according to the calling position information about the function in step S30 in the table 43 as in step S16, and the determination is performed in step S32. If the type of the line is “UNDEF” information described by referring to FIG. 13, then the data is set in step S31 in the table of the name uniquely given by the C++ compiler and the formal name, that is, the work table 46, and the determination is performed in step S32.

If it is determined in step S32 that the read of the file has been completed, the file is closed in step S33, the contents of the table 43 are sorted by a function name in step S34, and the lower modules are sorted according to calling position information and a lower module link is assigned in step S35, thereby terminating the process.

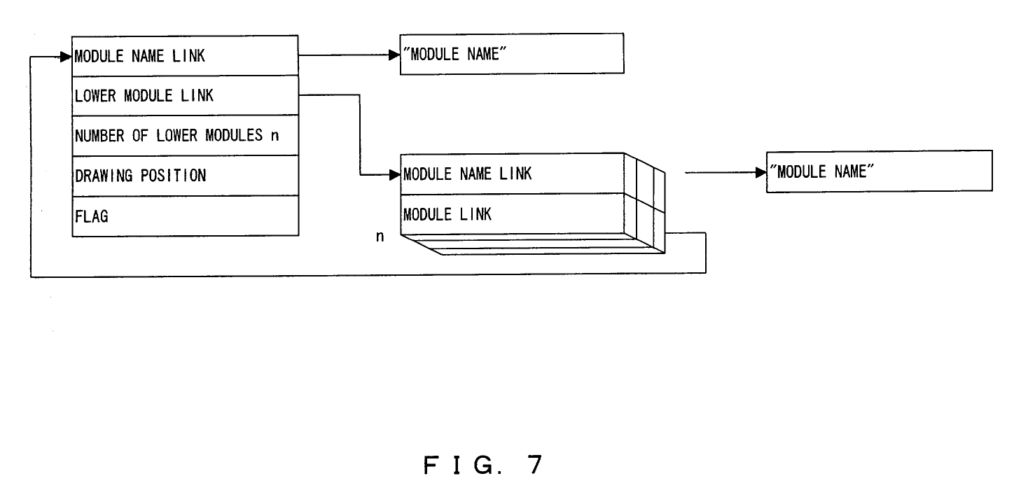

FIG. 7 shows an example of the contents of the module link table for management of the link among the modules. Each module is assigned the storage areas for a module name link for link to a module name, a lower module link indicating the link to a lower module which is located at a lower hierarchical level than the current module, the number of lower modules, the position of the current module in the drawing on the screen, a flag to be set when the current module is the leading (most significant) module as described later, etc.

FIG. 8 shows an example of the contents of the dump list 40 generated in step S1. In FIG. 8, “block.o” in line 1 is the module name. The leftmost “[1]” in the bottom line refers to an index, and the rightmost “block.C” in the line refers to the name of the source file. According to the symbol information about the object, the source file name and the object file name can be obtained.

FIG. 9 shows an example of the contents of the work table 41 shown in FIG. 4. The work table stores an object name, a source file name, and a C++ flag, and is generated for each object.

FIGS. 10 and 11 show examples of the contents of the dump list 42 shown in FIG. 5. FIG. 10 shows symbol information used in obtaining a function name, etc. included in an object. The line containing “FUNC” as type refers to the data of a function (module).

FIG. 11 shows the relocation information about an object in the dump list 42, and a function name being called is obtained according to the relocation information.

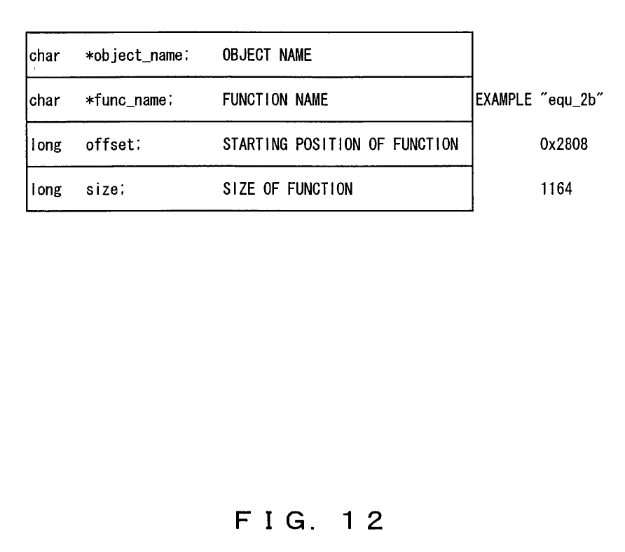

FIG. 12 shows an example of a table generated in step S15 according to the symbol information shown in FIG. 10. In FIG. 10, a table showing the function name, etc. existing in the object is generated for each function from the line describing “FUNC/GLOB”.

FIGS. 13 and 14 show examples of the contents of the dump list 45 generated in step S23 shown in FIG. 6. FIG. 13 shows the information used in obtaining the function name contained in an object as also shown in FIG. 10. FIG. 14 shows the relocation information as also shown in FIG. 11, and is obtained from the object corresponding to the C++ language. For example, “UNDEF” in line 4 from the bottom in FIG. 13 has a block pointer undefined to its right, which indicates that it is assumed to exist somewhere and is being called.

FIG. 15 shows an example of the contents of the work table 46 shown in FIG. 6. For example, “set_arg” in line 1 shown in FIG. 13 is a formal function name, and set_arg_FiPPcT1 in [] is a provisional function name given by the C++ compiler. FIG. 15 shows the correspondence between the formal function name and the provisional function name.

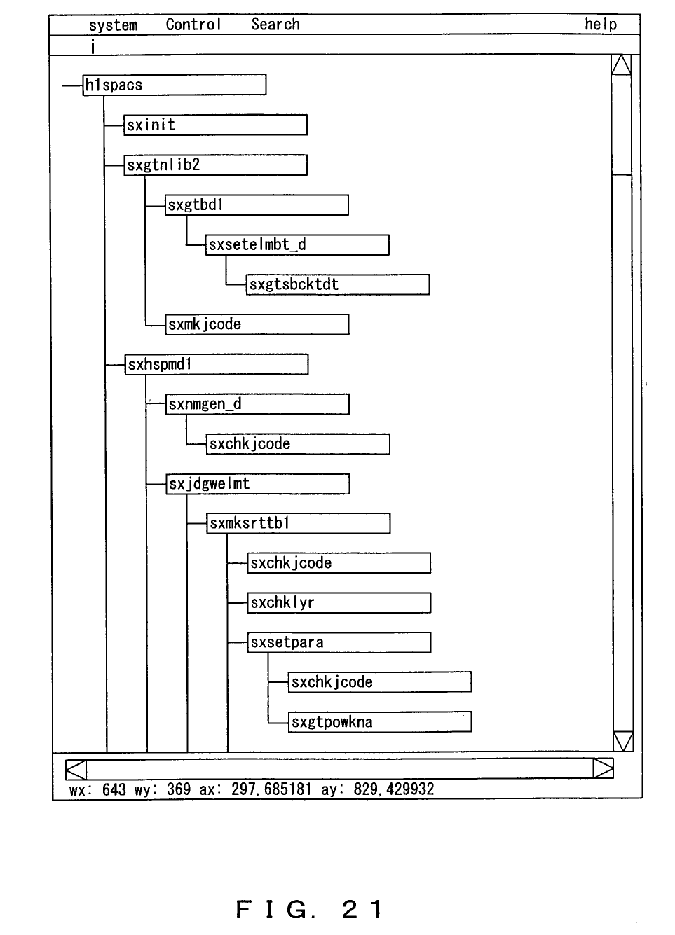

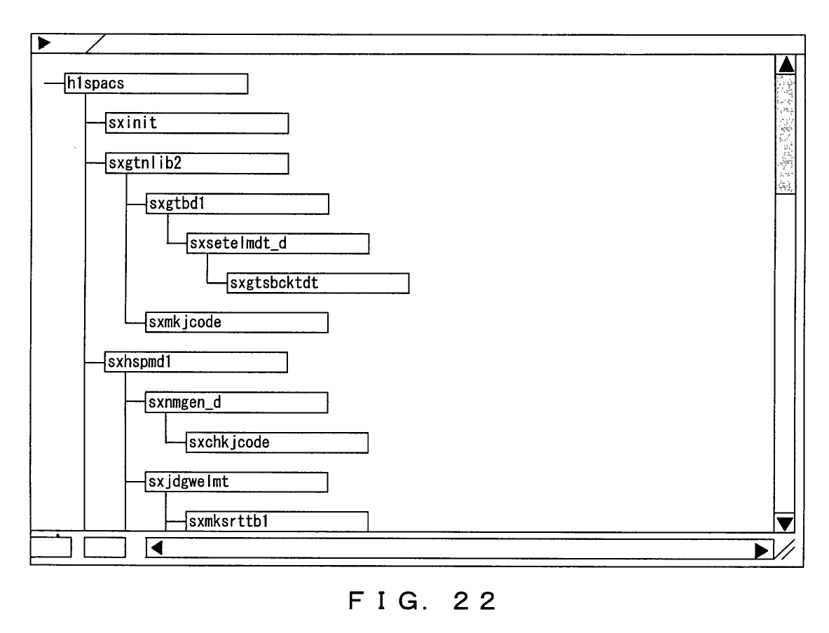

FIG. 6 shows the module link structure obtained by the process shown in FIGS. 4 through 6, and FIG. 17 shows its tree representation. The relationship between the module link structure and the screen display example is described later by referring to FIGS. 21 and 22.

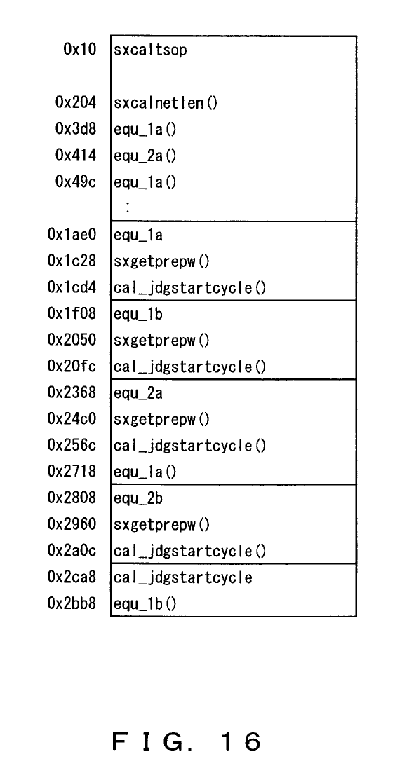

The first sxcaltsop shown in FIG. 16 has an offset (address) of 0x10 which is the Value defined in line 2 from the bottom shown in FIG. 10, and has a size (length) of 6848. Therefore, as described on top shown in FIG. 16, sxcalnetlen, equ_{—}1a,equ_{—}2a, etc. in the range of the offset of 0x10 to 6848 is linked as a lower module of sxcaltsop.

Similarly, in FIG. 10, equ_{—}1a having an index of 11, an offset of Oxlae0and a size of 1044 is linked to the lower modules named sxgetprepw and cal_jdgstartcycle.

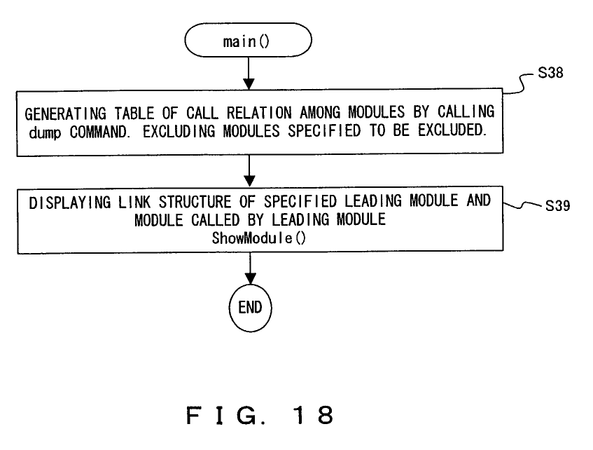

Described below is the process of displaying a generated module link structure. FIGS. 18 through 20 are flowcharts of the process of displaying a module link structure diagram. FIG. 18 is a flowchart of the entire displaying process. In FIG. 18, the calling relation among modules, that is, a link relation table (FIG. 7) is generated by the dump command described by referring to FIGS. 4 through 6, first in step S38. However, as described later, the table shown in FIG. 7 is generated by excluding the module specified as an exclusion module. Then, in step S39, the link structure of the module specified as a leading module, that is, the most significant module, and the module called by the most significant module is displayed, thereby terminating the process.

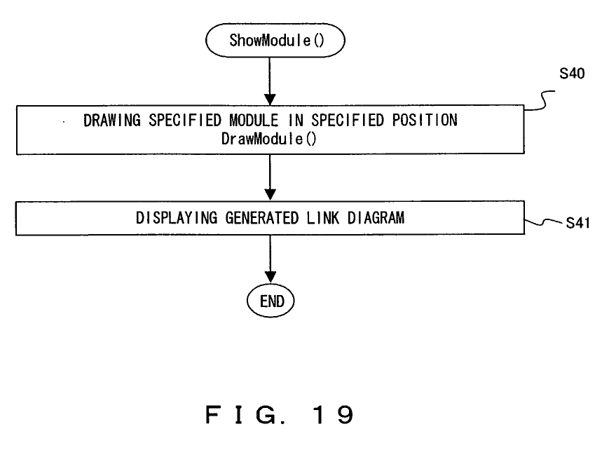

FIG. 19 is a detailed flowchart of step S39 shown in FIG. 18. First in step S40, for example, the module specified as a leading module is drawn in a specified position, and the link structure diagram indicating a lower module of the specified module is displayed in step S41, thereby terminating the process.

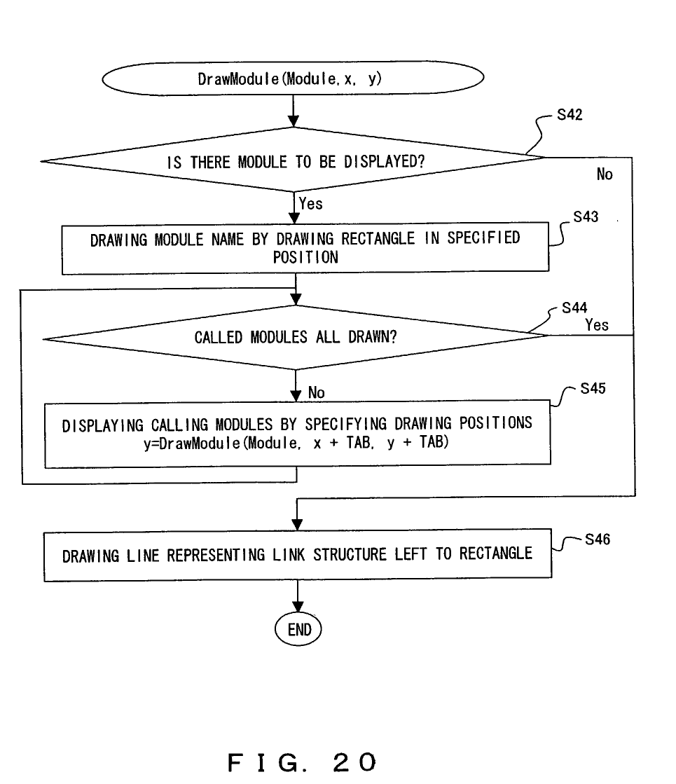

FIG. 20 is a detailed flowchart of the process of drawing a module in step S40 shown in FIG. 19. First, in step S42, it is determined whether or not there is a module to be displayed. If yes, then a rectangle indicating the module is drawn in a specified position in step S43, a module name is written therein, it is determined in step S44 whether or not all modules called by the leading module have been drawn. If there are still some more modules to be drawn, then the modules are displayed in the drawing position in step S45, and the processes in and after step S44 are repeated. If all modules to be called have been completely drawn in step S44, or if it is determined in step S42 that there are no modules to be displayed, then a line indicating the link structure is drawn to the left of the rectangle indicating the module in step S46, thereby terminating the process.

FIG. 21 shows an example of displaying a module link structure diagram. FIG. 22 shows the diagram in an HTML format. In these figures, the module name of the most significant module is “hlspacs” immediately followed by the modules “sxinit”, “sxgtnlib2”, “sxhspmd1”, etc. displayed in the link structure diagram.

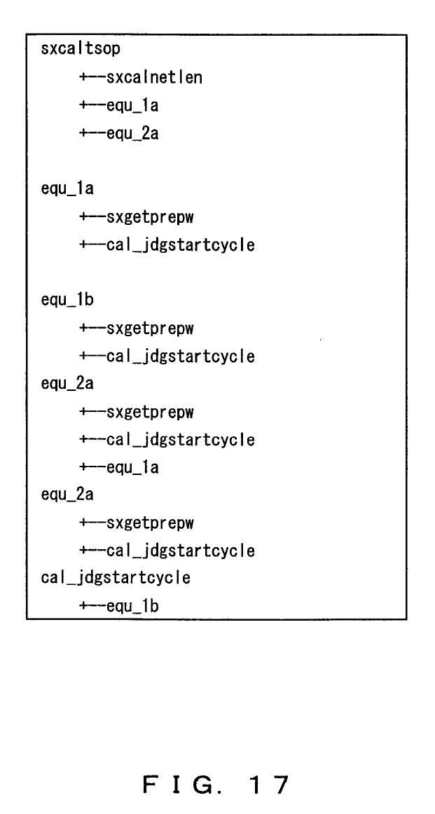

For example, in FIG. 17 showing a tree representation of FIG. 16, the most significant module is “sxcaltsop” immediately followed by the three module “sxcalnetlen”, “equ-1a”, and “equ-2a”. Furthermore, the module “equ-1a” has two lower modules “sxgetprepw” and “cal-jdgstartcycle”.

Described below is the method of editing a module link structure diagram after it has been shown on the display. As shown in FIGS. 18 through 20, modules are normally displayed in hierarchical graphics with generally the most significant function module, or a user-specified module, as a leading module. By the user clicking (hitting) an arbitrary displayed module with a mouse after the module link structure diagram has been shown on the display, the display style of the link structure diagram can be changed.

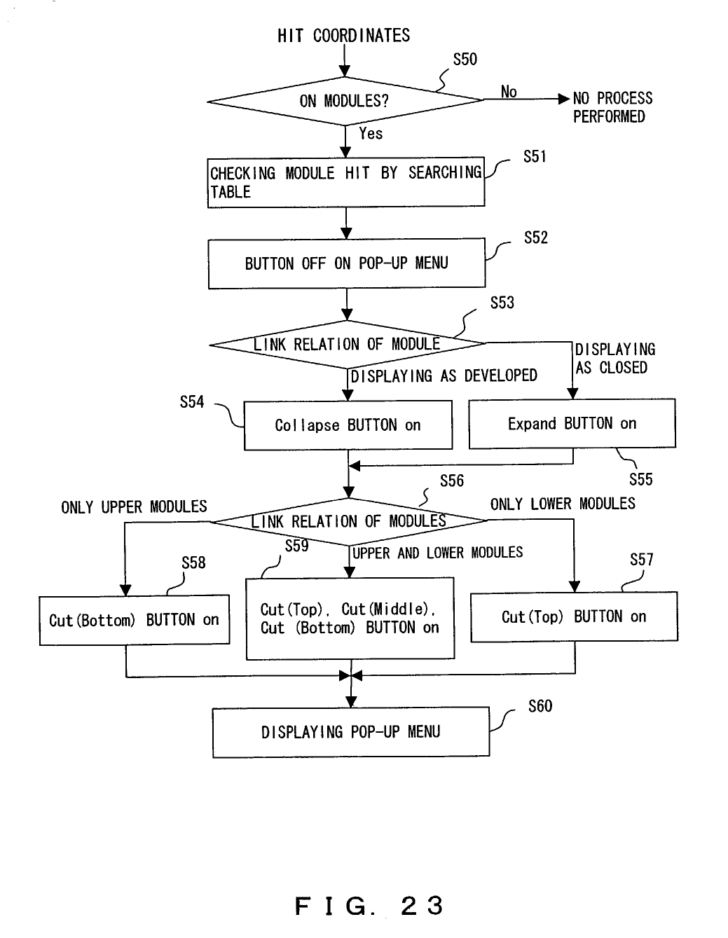

FIG. 23 is a flowchart of the process of displaying a pop-up menu to change the display style. In FIG. 23, it is determined in step S50 whether or not the image hit with the mouse is in the module, that is, in the rectangle. If not, no process is performed. If yes, the module link table is searched in step S51, the hit module is checked, all buttons on the pop-up menu are turned off in step S52, and then the link relation of the modules is determined in step S53.

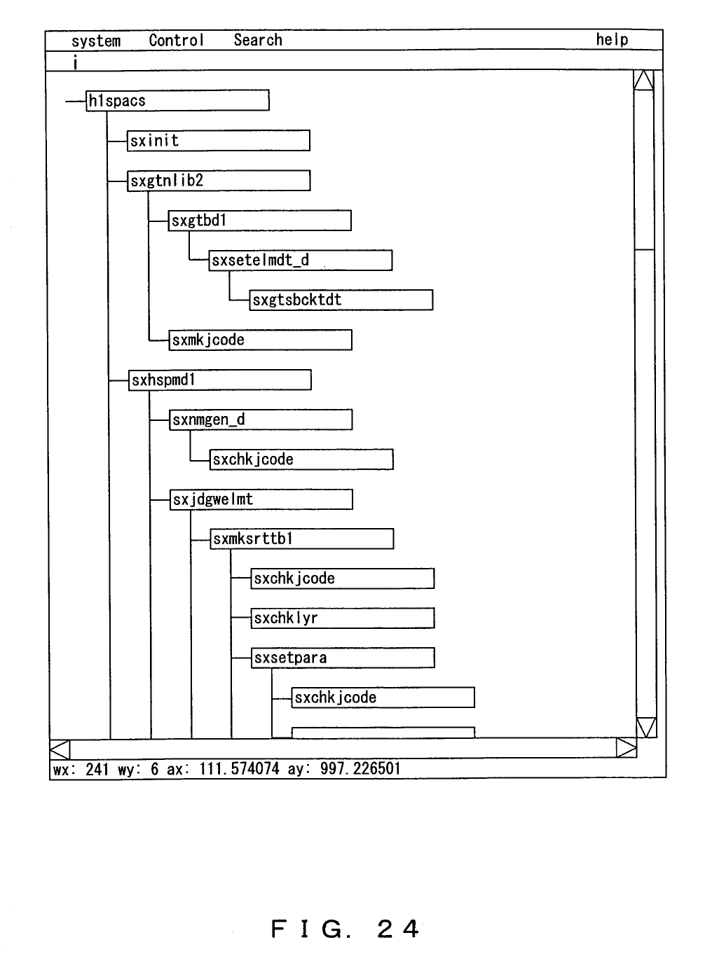

For the link relation to be determined in step S53, it is determined whether or not the module link structure diagram is being developed, that is, opened. FIG. 24 is a module link structure diagram being developed and displayed, and shows the entire module link structure in the largest possible display range on the screen.

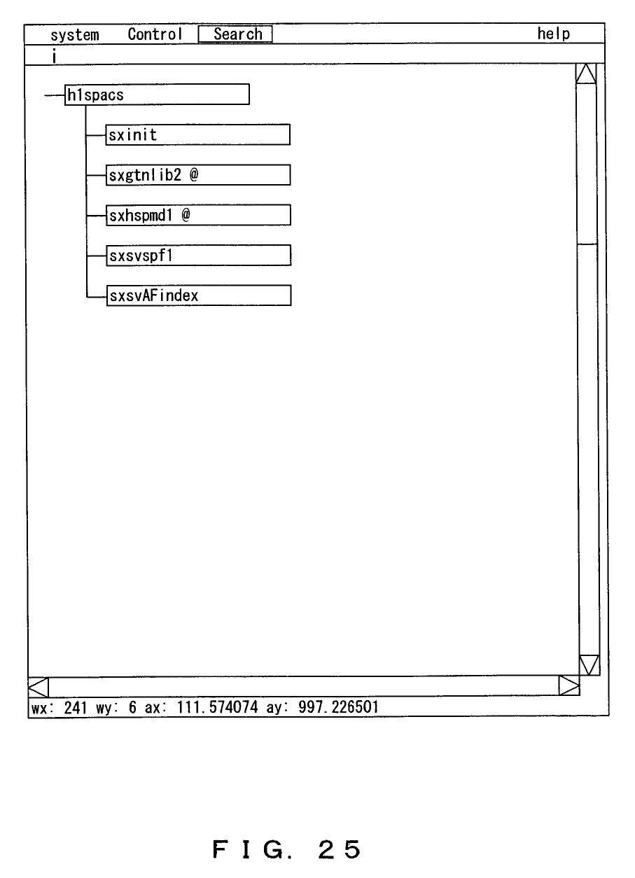

FIG. 25 is a link structure diagram displayed as closed. Only the most significant module and the five immediately lower modules are displayed, and further lower modules are not displayed.

If the link relation of modules is being developed and displayed in step S53 shown in FIG. 23, then the link relation of the modules is determined again in step S56 after the Collapse button is turned on in step S54. If the link relation of modules is displayed as closed in step S53 shown in FIG. 23, then the link relation of the modules is determined again in step S56 after the Expand button is turned on.

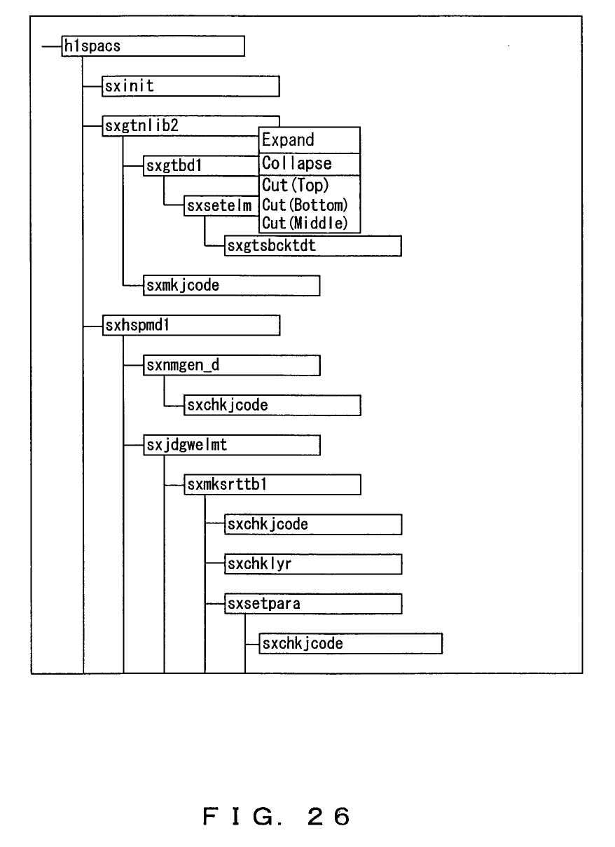

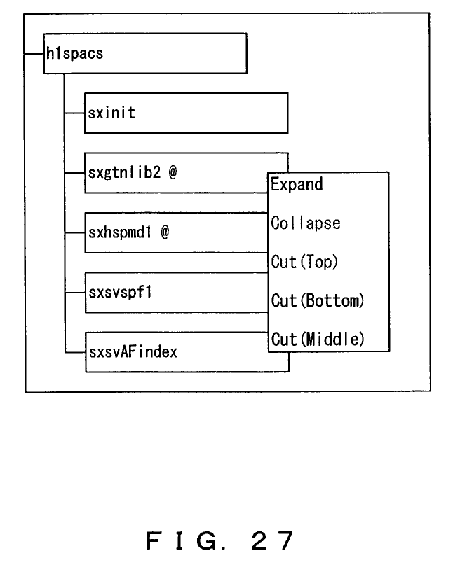

FIGS. 26 and 27 show an example of using the pop-up menu containing the Collapse button and the Expand button. If the user clicks the button (rectangular) “sxgtnlib2” of the mouse as shown in FIG. 26, then the pop-up menu is displayed. If the user selects “Collapse”, then only the modules higher than the clicked module and the modules at the equal hierarchical level are displayed as shown in FIG. 27, but all lower modules are not displayed. Since lower modules are not displayed, the symbol @ indicating that the modules not displayed are lower modules is displayed on the button as shown in FIG. 27.

If the mouse is clicked on the button with @, the pop-up menu is displayed, and the “Expand” is selected as shown in FIG. 27, then the lower modules including the modules at the equal hierarchical level are displayed again in the link structure diagram as shown in FIG. 26.

The link relation of the modules determined in step S56 shown in FIG. 23 refers to: the most significant module, that is, the clicked module has the link relation only to the lower modules on the display screen; the least significant module, that is, the clicked module has the link relation only to the upper modules on the display screen; or a module which is not the most significant or the least significant module, and has the link relation to both upper and lower modules. If there is the link relation only to lower modules, then after turning on the cut (top) button in step S57, the pop-up menu is displayed in step S60. If there is the link relation only to upper modules, then after turning on the cut (bottom) button in step S58, the pop-up menu is displayed in step S60. If there is the link relation to both upper and lower modules, then after turning on the cut (top) button, the cut (middle) button, and the cut (bottom) button in step S59, the pop-up menu is displayed in step S60.

In the process of displaying a pop-up menu shown in FIG. 23, the event process unit between the mouse 12 and the module link diagram editing unit 28 shown in FIG. 2B, but not shown in the attached drawings receives an instruction from the user through the mouse 12, and the module link diagram editing unit 28 performs a corresponding process.

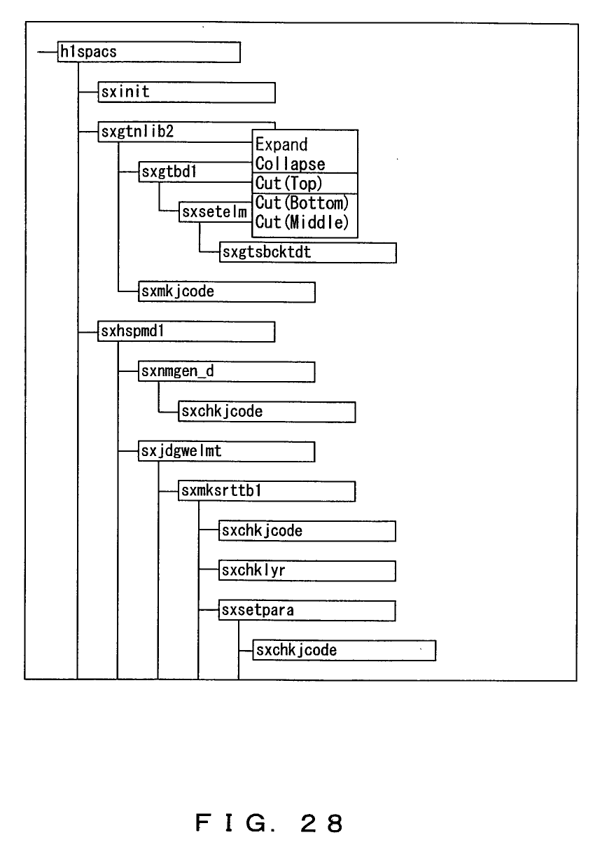

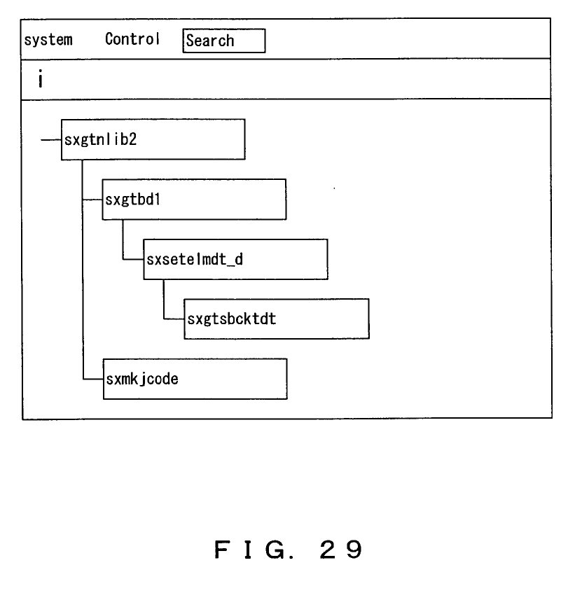

FIGS. 28 and 29 show an example of the screen displayed when the user selects a cut (top) button on the pop-up menu. In FIG. 28, if the pop-up menu is displayed by the user clicking with the mouse on the button “sxgtnlib2”, and the user selects “cut (top)”, then the module link structure diagram including the module as the leader as shown in FIG. 29 is generated and displayed.

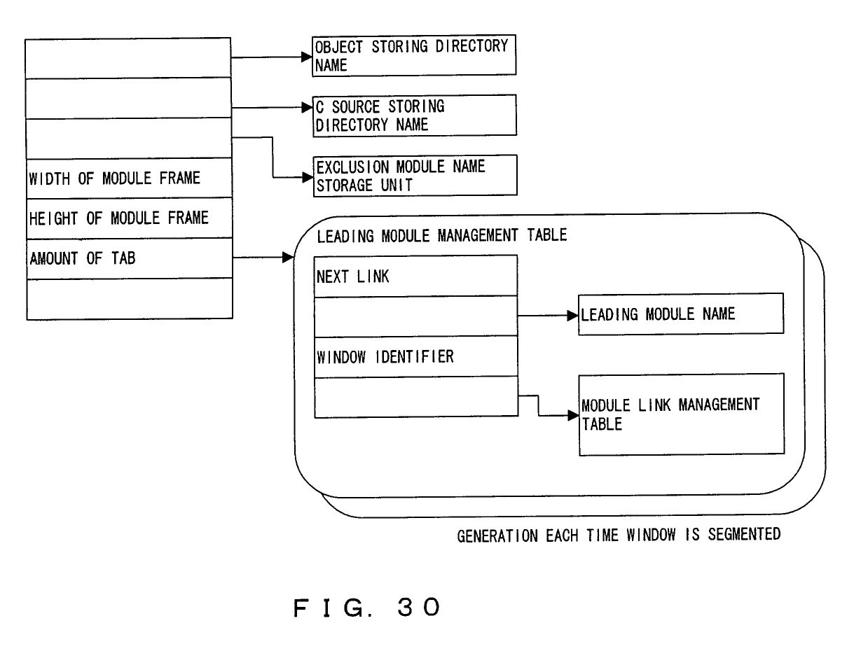

FIG. 30 shows an example of a control table of the module link structure diagram including the leading module management table displayed when the leading module is changed on the display screen. Although the control table is not shown in FIG. 2B, but is controlled by, for example, the link table management unit 22. The leading module management table is generated and used for control of screen display, etc. each time the screen is displayed with an arbitrary module as the leading module, that is, each time a window is segmented and displayed.

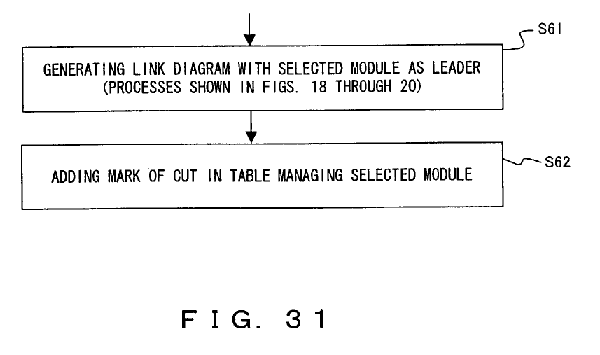

Described below is the process performed when the cut (top) button, the cut (middle) button, and the cut (bottom) button are selected by the user on the pop-up menu. FIG. 31 is a flowchart of the process performed when the cut (top) button is selected on the pop-up menu. In FIG. 31, a link structure diagram is generated in step S61 with the module selected set as the leading module, and a flag indicating that upper modules are cut off is set in step S62 on the table of the selected module in the module link table shown in FIG. 7.

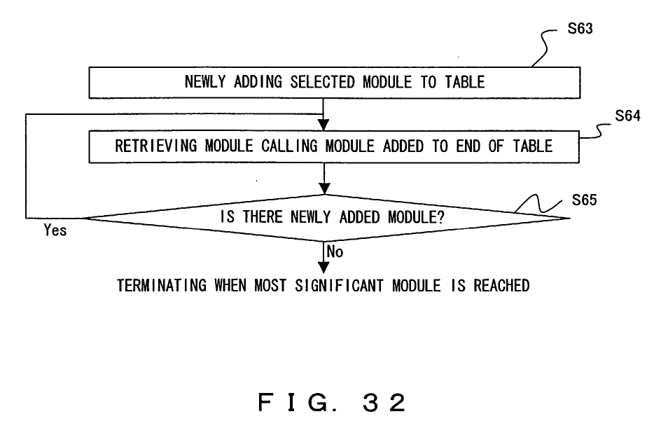

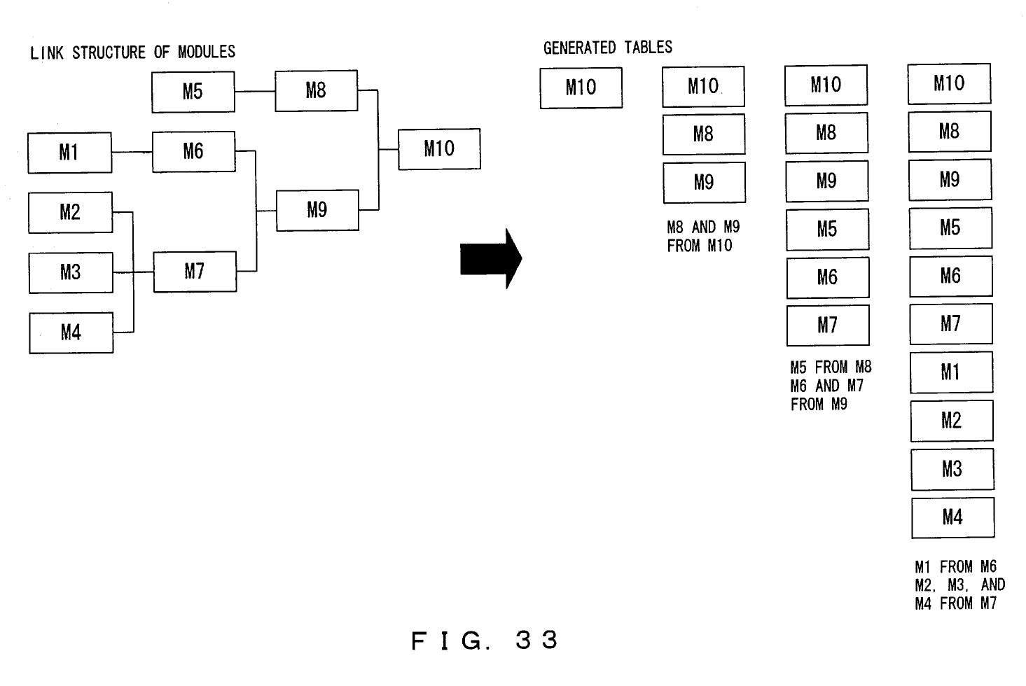

Described below is the process performed when the cut (middle) button is selected on the pop-up menu. FIG. 32 is a flowchart of the process of generating a table showing the link state to upper modules. The flowchart is described below by referring to an example of generating the table shown in FIG. 33.

The module selected in step S63 shown in FIG. 32, that is, the module on which the pop-up menu is displayed, is newly added to the table to be generated. In FIG. 33, assuming that the module M10 is to be selected as a cut (middle) process target, the block of M10 is added to the leftmost of the table as shown on the right in FIG. 33.

In step S64 shown in FIG. 32, the module calling the added module is retrieved and added to the end of the table. In FIG. 33, the modules calling the M10 are M8 and M9. Therefore, the modules M10, M8, and M9 are added to the right of the module M10 in the table.

In step S65 shown in FIG. 32, it is determined whether or not there is a newly added module. If yes, then the processes in and after step S64 are repeated. If there are no added modules and the most significant module is reached, then the process terminates. In the process above, the table shown on the right in FIG. 33 is generated.

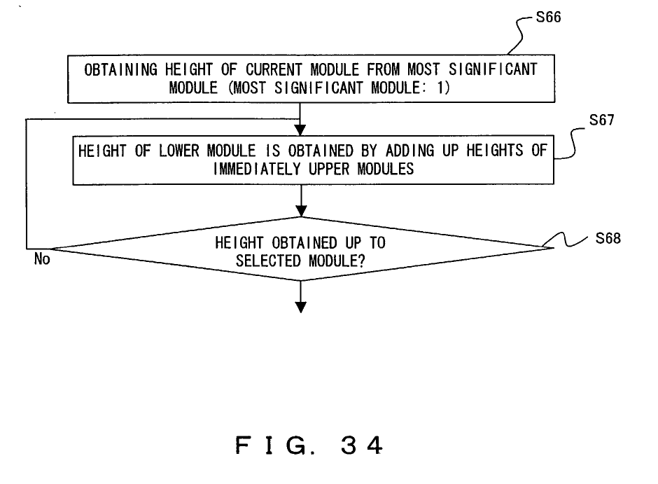

FIG. 34 is a flowchart of the process of obtaining the width in the vertical direction to be generated on the screen corresponding to each module, that is, the height, when a rectangle corresponding to each module is drawn on the display screen. In FIG. 34, first in step S66, the height in the vertical direction of the area in which each module is to be displayed is obtained from the most significant module. It is obvious that the height of each area is 1 for the most significant module.

The processes in FIGS. 31, 32, and 34 are basically performed by the module link diagram editing unit 28 shown in FIG. 2B. The result is passed to the module link diagram generation unit 23 through the link table management unit 22, thereby redisplaying the link structure diagram.

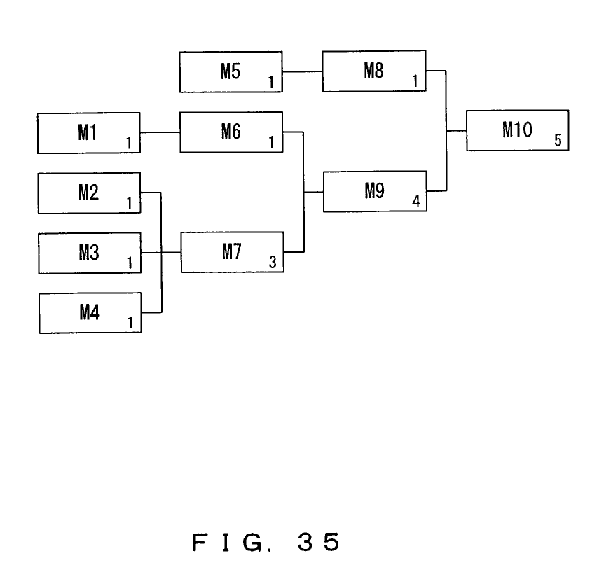

FIG. 35 shows a module link structure to be drawn. The height of each of the most significant modules M1 through M4 is 1 as described on the right of each rectangle.

In step S67 shown in FIG. 34, one lower module is selected, and it is assumed that its height is obtained by adding up the heights of the modules immediately higher than the selected module. For example, in FIG. 35, the module M7 has three modules immediately higher, that is, the modules M2 through M4 the height of each of which is 1. Therefore, the heights are added up, and the sum of 3 is assigned as the height of the module M7.

In step S68 shown in FIG. 34, it is determined whether or not the heights have been obtained up to the selected module, that is, the module M10 shown in FIG. 35 in this example. If not, the processes in and after step S67 are repeated. If yes, then the process terminates. In FIG. 35, the height obtained for each module as described above is written at the right end of each rectangle indicating a module.

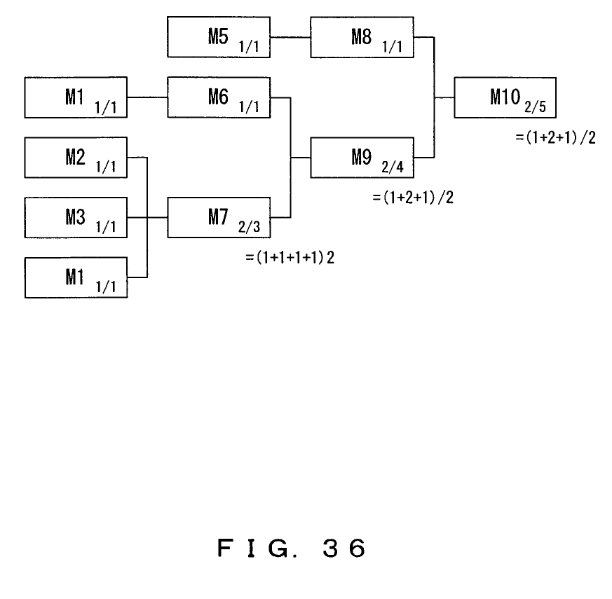

FIG. 36 shows the result of the operation of determining where a module is to be drawn in width in the vertical direction, that is, the height, of the area in which each module obtained in FIGS. 34 and 35 is to be displayed. In this example, in the range of the height obtained corresponding to each module, it is determined in which position the module is to be drawn.

For example, since the height of the most significant module is 1, the drawing position is 1, and since the drawing position is 1 with the height of 1, the drawing position is 1/1 as shown at the right end of each module in FIG. 36.

The drawing position of a lower module is determined by the following equation.

Drawing Position=(sum of positions of upper modules+1)/2,

1 is assigned to the most significant module.

For the module M7 shown in FIG. 36, the sum of the positions of the upper modules M2 through M4 is 3, and the value obtained by adding 1 to the sum of 3, and dividing the sum of 4 by 2 is 2. As described at the right end of the module, the drawing position of the module M7 is 2/3 indicating the position of 2 in the height of 3. Similarly, the drawing positions of the modules M9 and M10 are 2. For example, 2/5 indicating that the position of the module M10 is 2 in the height of 5 is described at the right end of the module.

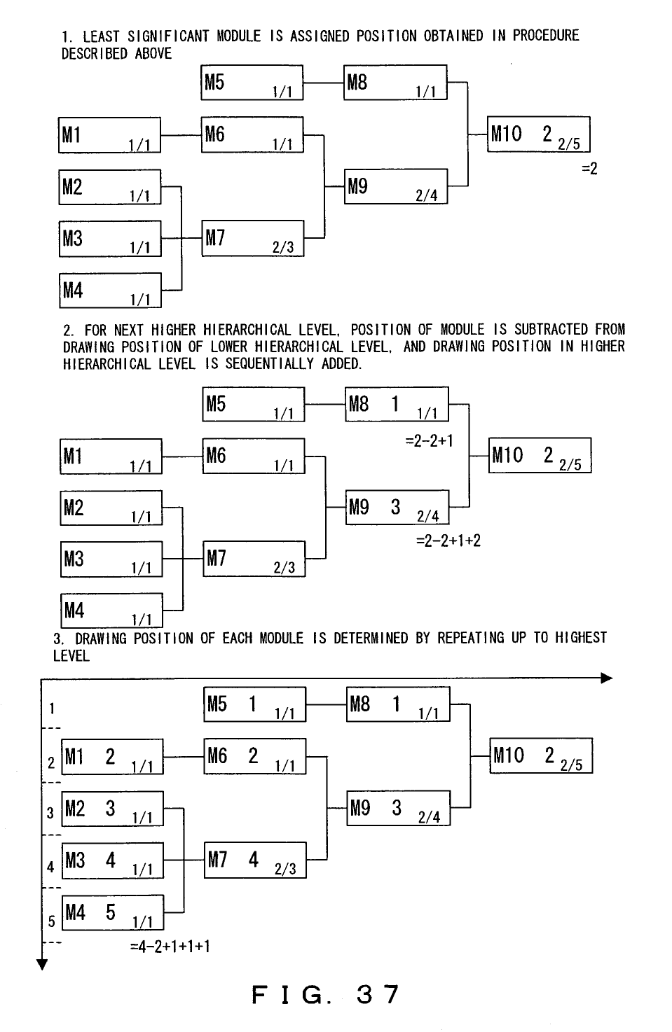

FIG. 37 shows the method of determining the drawing position on the display screen indicating where a rectangle indicating each module is to be drawn on the display screen. In FIG. 36, it is determined in which position each module is to be drawn in the widths generated for the module in the vertical direction, that is, in the height. The operation of determining in which position the rectangle indicating each module is to be drawn in the total height on the display screen is performed as shown in FIG. 37.

In \mathring{1} shown in FIG. 37, for the least significant module, that is, M10 in this example, the drawing position 2 for the module M10 last obtained in FIG. 36 is used as is and drawn as shown in FIG. 35. Then, as shown by the least significant module M10 in \mathring{1}, the final position of 2 is written in the center of the rectangle.

Then, in \mathring{2} shown in FIG. 37, the drawing positions of upper modules M8 and M9 to the module M10 are determined. For example, for the module M8, the value of 2 indicating the position in height is subtracted from the final drawing position 2 of the lower module M10, \mathring{1} as the position in its own height is added, the final drawing position is 1, the value of the position of 2 in the height is subtracted from the final drawing position of 2 of the module M10 for the module M9, and the value of the position in the height for the module M8 which is an upper module to the module 10 and is at the same hierarchical level as the module M9, that is, 1, is added to the value of 2 corresponding to the module M9, thereby determining the final drawing position of 3.

In \mathring{3} shown in FIG. 37, the similar operation is performed, thereby determining the drawing position of each module from the most significant module M1 to the module M4. Thus, each module is drawn in the determined drawing position.

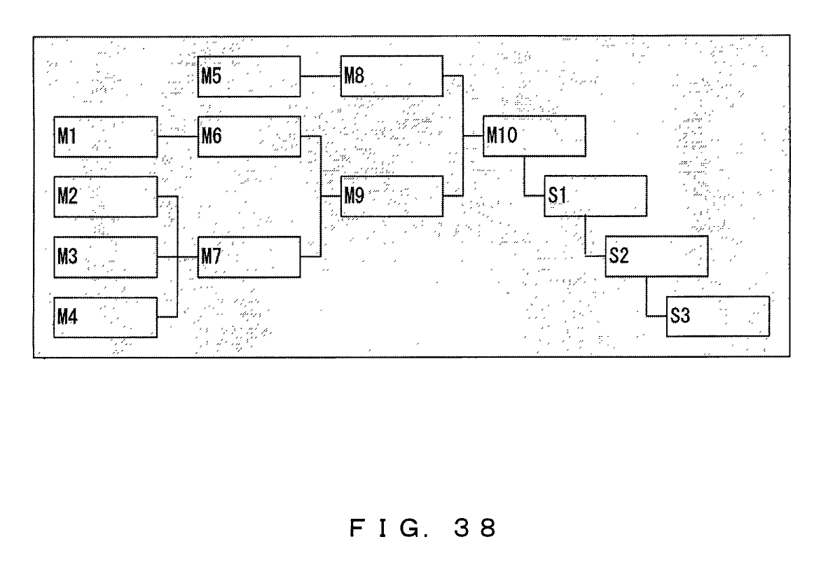

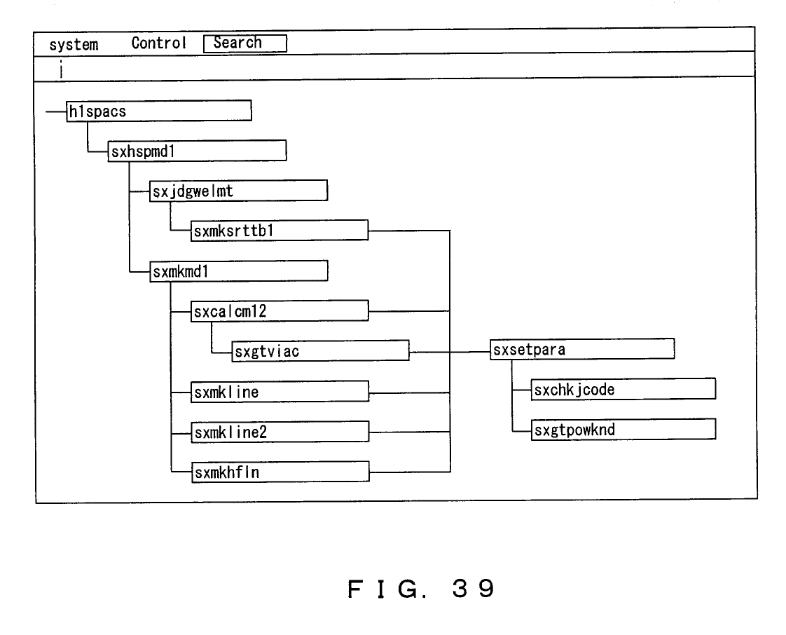

FIG. 38 shows an example of a module link structure when a cut (middle) is selected by clicking the module M10. In addition to the above mentioned upper modules, lower modules S1, S2, and S3 are displayed. FIG. 39 also shows an example of displaying a screen when a cut (middle) is selected on the pop-up menu. A lower hierarchical module to the selected module is drawn according to the flowchart of the processes shown in FIGS. 18 through 20.

According to the present embodiment, using the contents of the exclusion module indicative file 14 shown in FIG. 2B, a module not to be displayed in the module link structure diagram such as common modules to be called by any module can be excluded from the module link structure diagram or can be controlled not to be displayed.

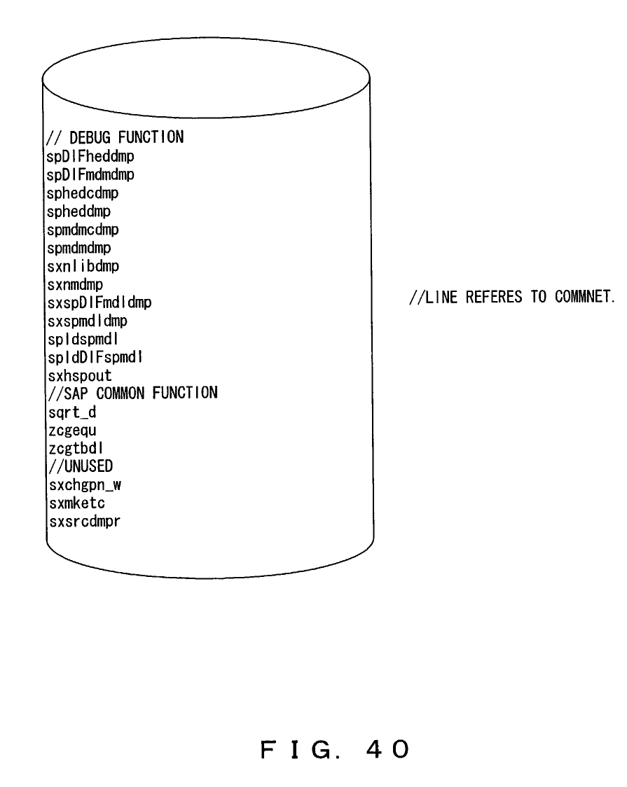

FIG. 40 shows the contents of the exclusion module indicative file 14. When exclusion control is performed using the contents of the exclusion module indicative file, and when a module link structure is generated according to the flowcharts shown in FIGS. 4 through 6, the module stored in the exclusion module indicative file is not displayed in the module link structure diagram by not generating a module link table corresponding to the module defined in the file. In this control system, a module to be excluded cannot be controlled to be displayed or not.

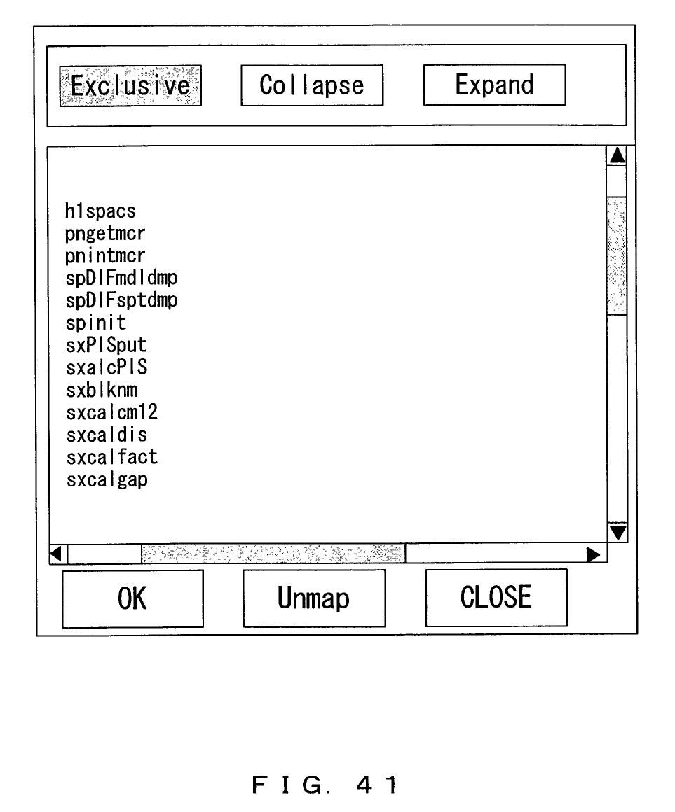

Another method is to use a control list menu. FIG. 41 shows an example of a control list menu, and an exclusion module is a module to be displayed when the exclusive button is selected on the menu.

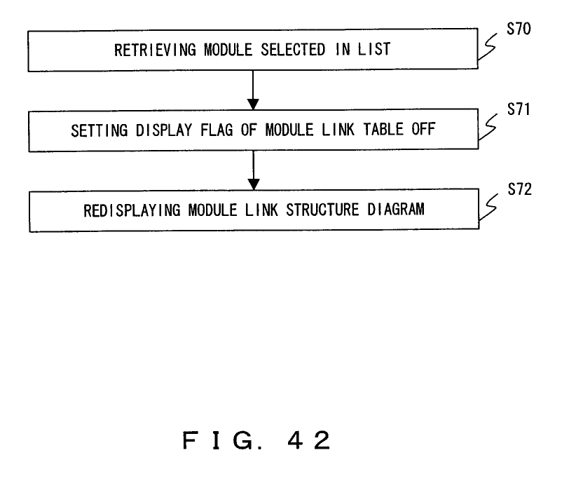

FIG. 42 is a flowchart of the exclusion control process using the control list menu. In FIG. 42, the module selected in the control list is retrieved in step S70, a display flag is set off in step S71 in the module link table, that is, the table shown in FIG. 7, the module link structure diagram is redisplayed in step S72, thereby terminating the process. In this system, the module can be redisplayed by setting on the display flag.

The module link structure diagram displayed on the display screen can be printed out on the printer. In printing out the diagram, the data displayed on the display screen is converted into the postscript (the language having the graphics capability, and transmitted to the printer. For example, two sizes of printing paper, that is, A4 long size and A4 wide size, can be used.

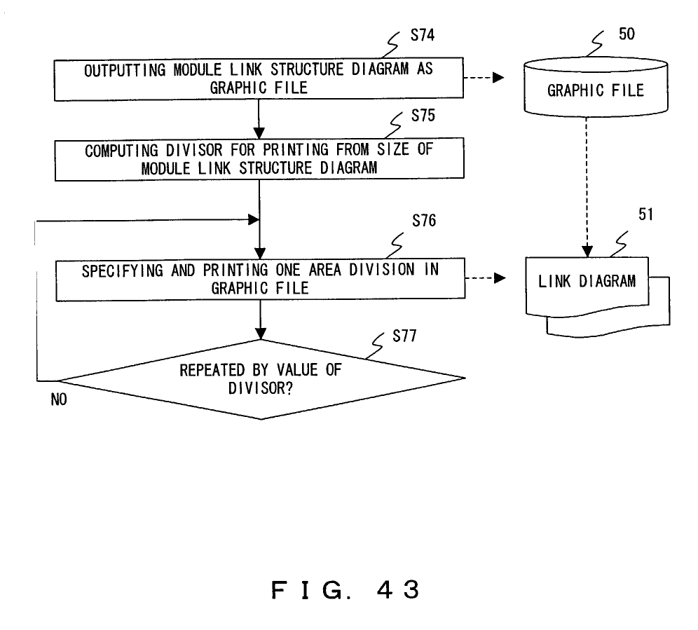

FIG. 43 is a flowchart of the printing process. In step S74, the data of the module link structure diagram is output as a graphic file, the data of the module link structure diagram is output as a graphic file, thereby generating a graphic file 50, the divisor to be used in printing is computed from the entire size of the module link structure diagram in step S75, and one area division in the graphic file is specified and a link diagram 51 is output as a print result in step S76. In step S77, it is determined whether or not the printing process is repeated for each division, and if not, then the processes in and after step S76 are repeated, and the process terminates when the printing process is repeated for each division.

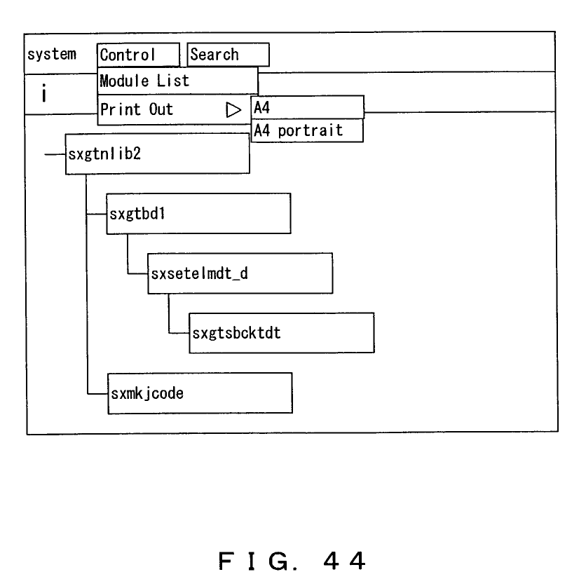

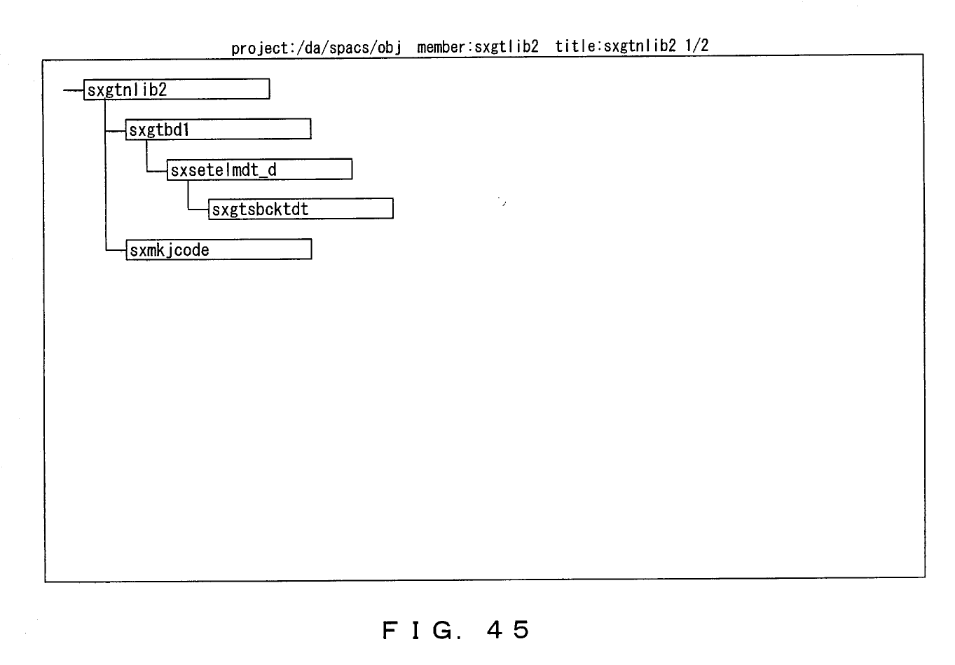

FIG. 44 shows the selection of a button in the printing process. In FIG. 44, when printout is selected on the pop-up menu, a module link structure diagram is printed out. FIG. 45 shows an example of a printing result.

According to the present embodiment, the function of automatically generating a document in the HTML format is provided in the module link structure diagram displayed on the display screen, and the generated document can be freely referred to in the WWW browser. This function is performed by the HTML document generation/print unit 27 shown in FIG. 2B.

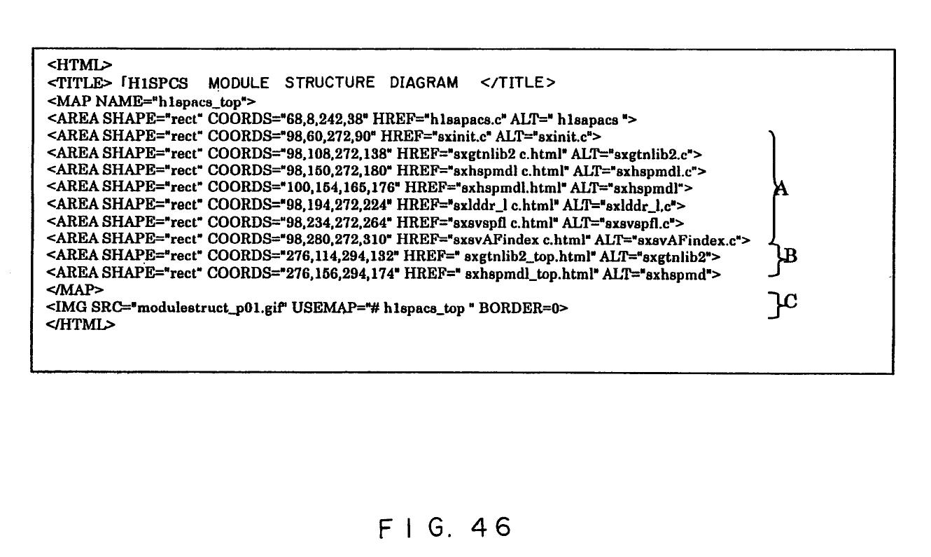

FIG. 46 shows an example of an automatically generated HTML format. In this example, the contents of the screen are output as a graphic file, and the document including the graphic file is displayed in the portion C.

In this example, a MAP statement and an AREA statement are inserted such that the C source can be displayed when the rectangular area on the screen representing a module in the graphic file is selected in the WWW browser. This refers to the portion A shown in FIG. 46. Furthermore, a link to another module link structure diagram is inserted as an AREA statement indicated by B shown in FIG. 46 into the HTML document such that the other module link structure diagram can be displayed when a module on the display screen is selected by the WWW browser.

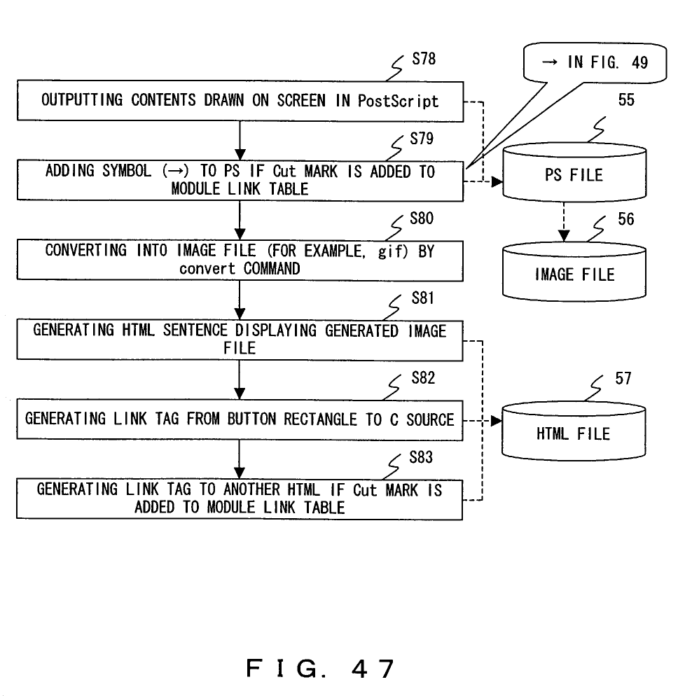

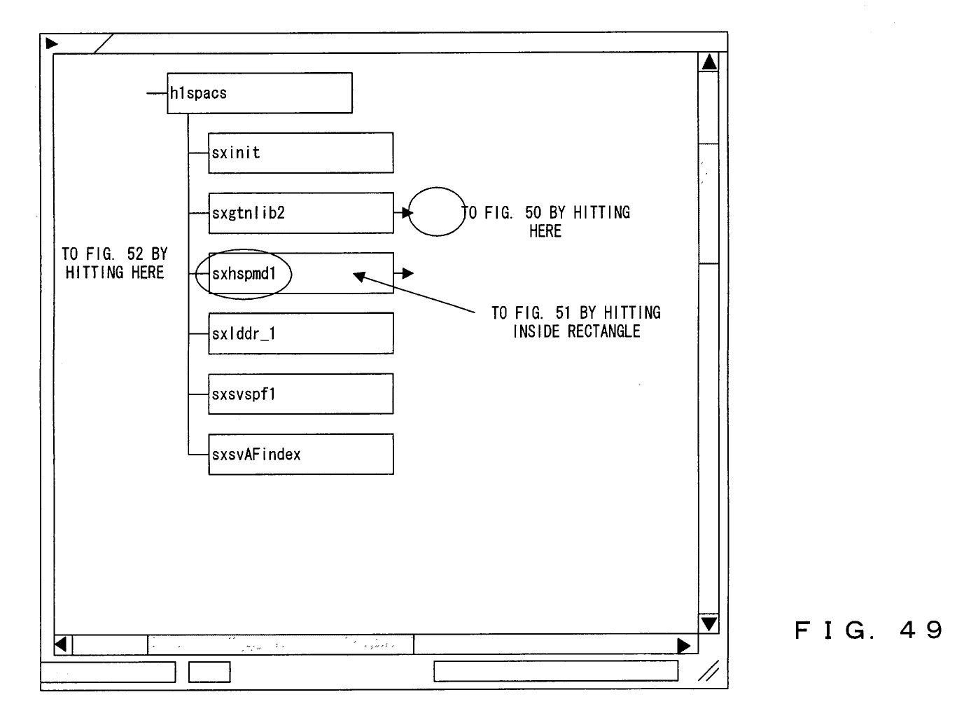

FIG. 47 is a flowchart of the HTML document generating process. In FIG. 47, first in step S78, the contents of the drawing on the screen are output in the postscript (PS), and a PS file 55 is generated. In step S79, if the mark, that is, the flag, indicating the target of cut (top) described by referring to FIG. 31 is set, then the graphics indicated by the arrow is added to the PS file 55 (refer to FIG. 49). In step S80, the convert command converts the PS file 55 into an image file 56, for example, into a graphic interchange format (GIF) for storage of image data through Internet.

In step S81, an HTML document for display of the generated image file 56 is generated and stored in an HTML file 57. In step S82, a link tag from the rectangular area including the drawing of a button to the C source is generated for use in case the rectangular area is selected in the WWW browser. In step S83, if the mark, that is, the flag, indicating the cut is set in the module link table, then a link tag to another HTML document is generated so that another module link structure diagram can be displayed when a module is selected, and the link tags are stored in the HTML file 57, thereby terminating the process.

The position of the rectangular area in step S82 can be specified by setting, for example, 68, 8 around the center in line 4 shown in FIG. 46 as the coordinates of the upper left vertex of the rectangular area, and setting 242, 38 as the coordinates of the lower right vertex.

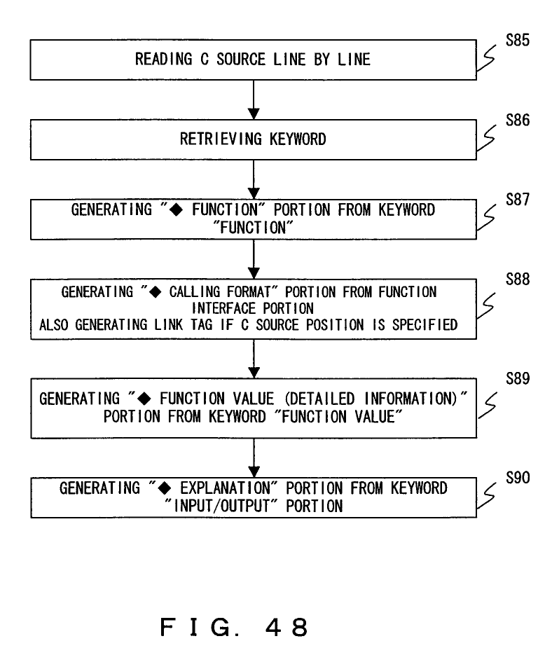

Furthermore, according to the present embodiment, the input/output specifications of a function can be generated in the HTML format using the contents of the C source file 30 described above by referring to FIG. 3 from the comment described by a predetermined keyword mentioned later. FIG. 48 is a flowchart of the process of generating the function input/output specifications.

First, in step S85, the contents of the C source file are read line by line, the a keyword is retrieved in step S86, and the functional portion in the input/output specifications is generated from the keyword “function” in step S87.

Then, in step S88, a portion in a calling format is generated from the portion of the function interface, a link tag to the position of the C source is generated if the position is specified. In step S89, the portion of the function (detailed information) of the input/output specifications is generated from the contents of the keyword “function value”. In step S90, the explanatory portion of the input/output specifications is generated from the “input/output” portion of the keyword, thereby terminating the process.

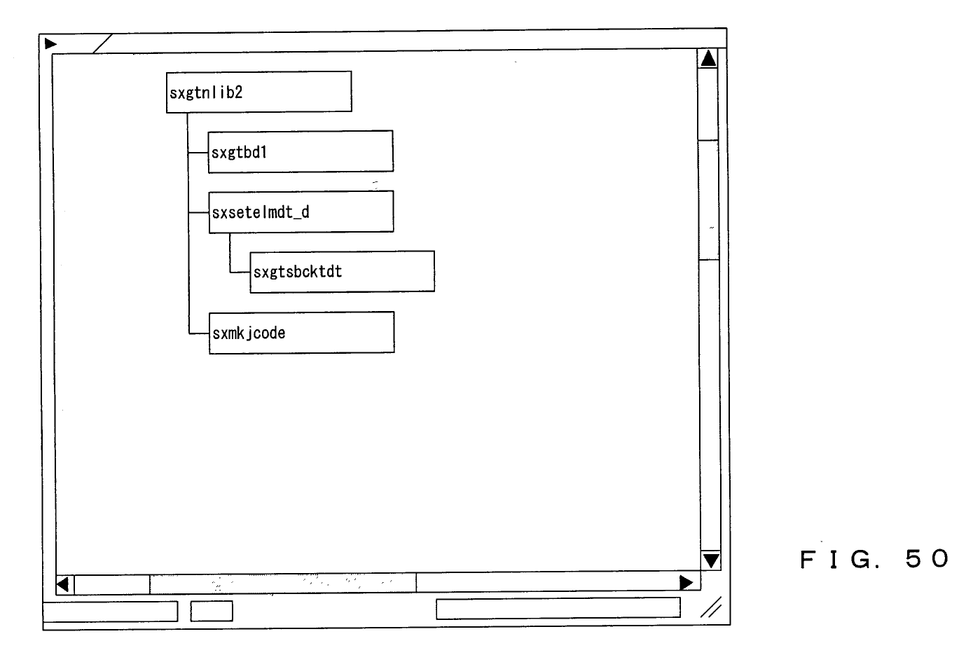

FIGS. 49 through 52 show practical examples of the processes performed as shown in FIGS. 47 and 48. First, when the arrow at the right end of the button “sxgtnlib2” is clicked (hit) by the mouse as shown in FIG. 49, another HTML (another module link structure diagram) shown in FIG. 50 is displayed through the link tag generated in step S83 shown in FIG. 47.

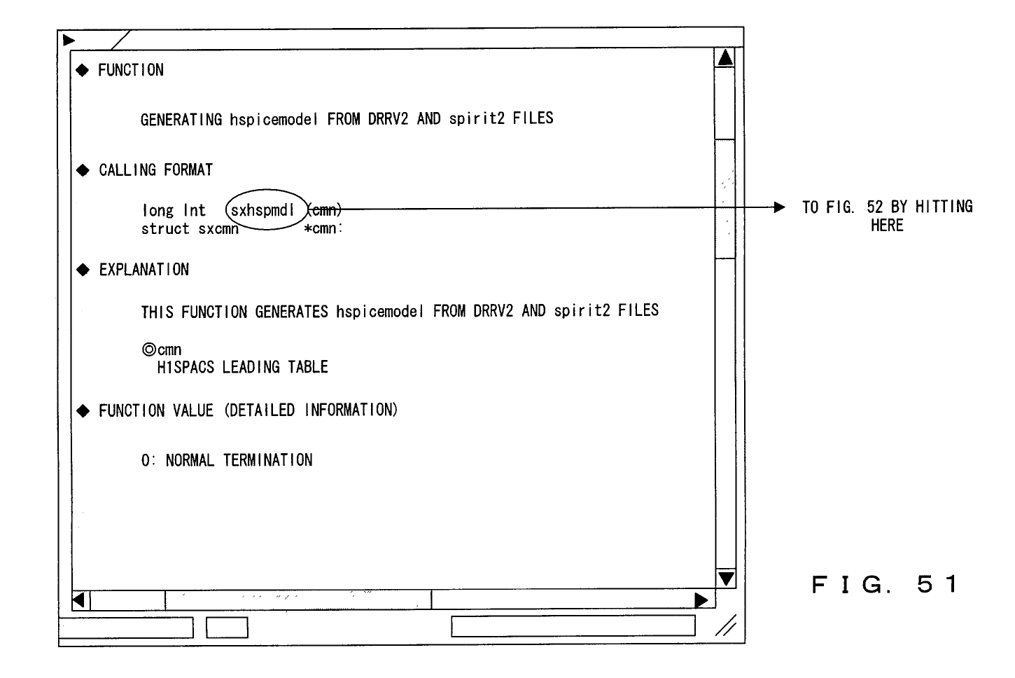

When the portion other than the module name of the button “sxhspmd1” shown in FIG. 49 is clicked, the contents of the C source file are displayed as shown in FIG. 51 using the link tag generated in step S82 shown in FIG. 47.

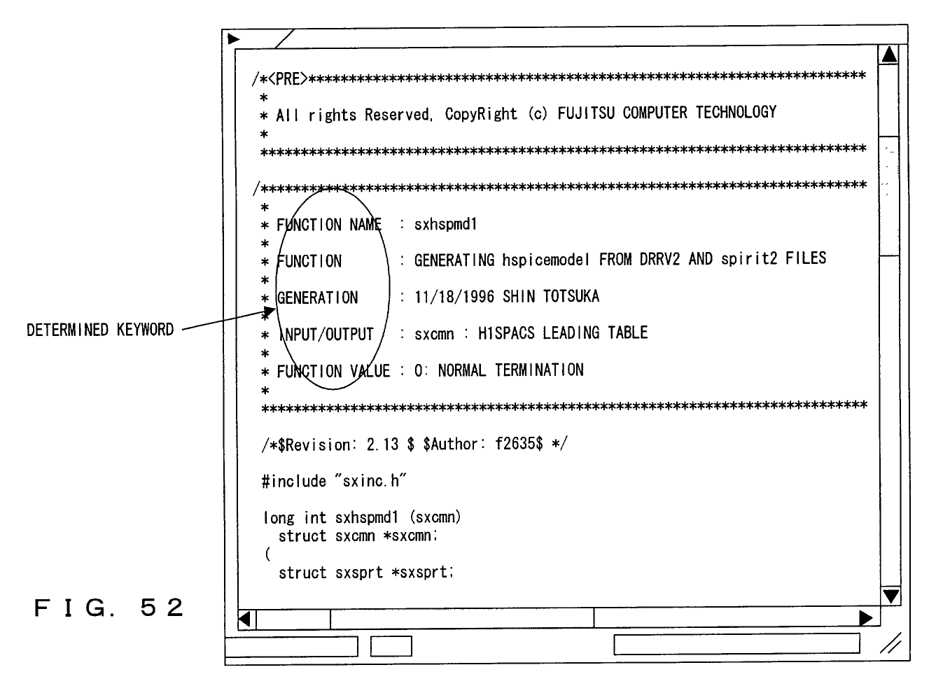

If the portion of the module name of the button is clicked or “sxhspmd1” as a function name in the calling format is clicked as shown in FIG. 51, then the screen shown in FIG. 52 is displayed, a link can be established to the C source, and the C source can be referred to while interpreting a document. FIG. 52 shows a (predetermined) keyword described in step S86 shown in FIG. 48.

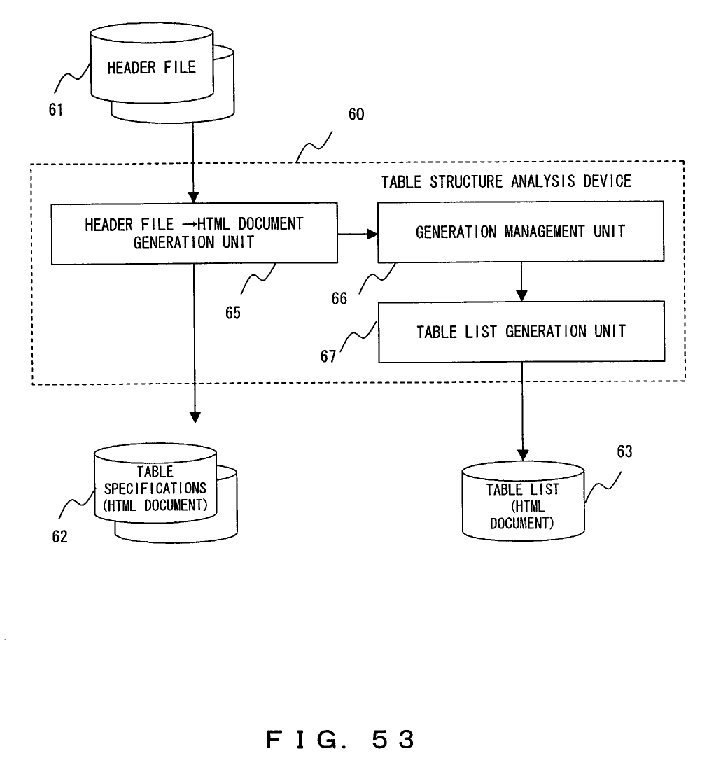

According to the present embodiment, the function of generating an internal table list and the specifications of each table as an HTML document can be provided using the contents of the header file 31 shown in FIG. 3. FIG. 53 is a block diagram of the configuration of a table structure analysis device 60 for generating table specifications 62 and a table list 63 from a header file 61.

In FIG. 53, the table structure analysis device 60 comprises a header file HTML document generation unit 65, a generation management unit 66, and a table list generation unit 67.

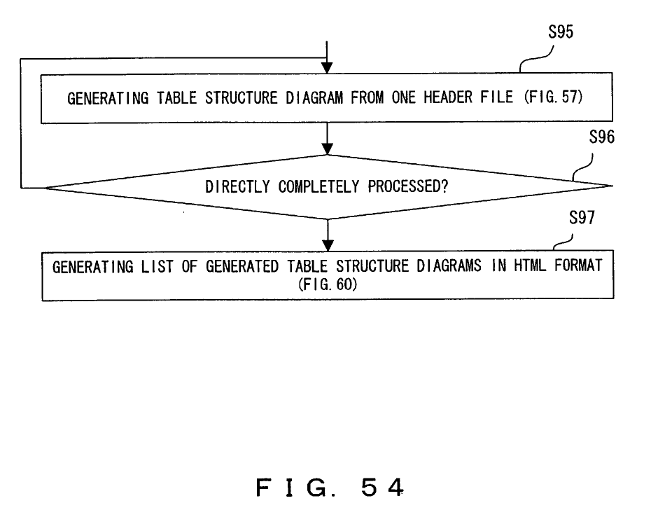

FIG. 54 is a flowchart of the entire process of analyzing an internal table structure. In FIG. 54, a table structure diagram is generated from one header file in step S95, it is determined in step S96 whether or not the structure diagram generating process has not been completed on all header files in the directory. If it has been completed, then the processes in and after step S95 are repeated. If it has been completed, then a table list including the table structure diagram is generated in step S97 is generated in the HTML format.

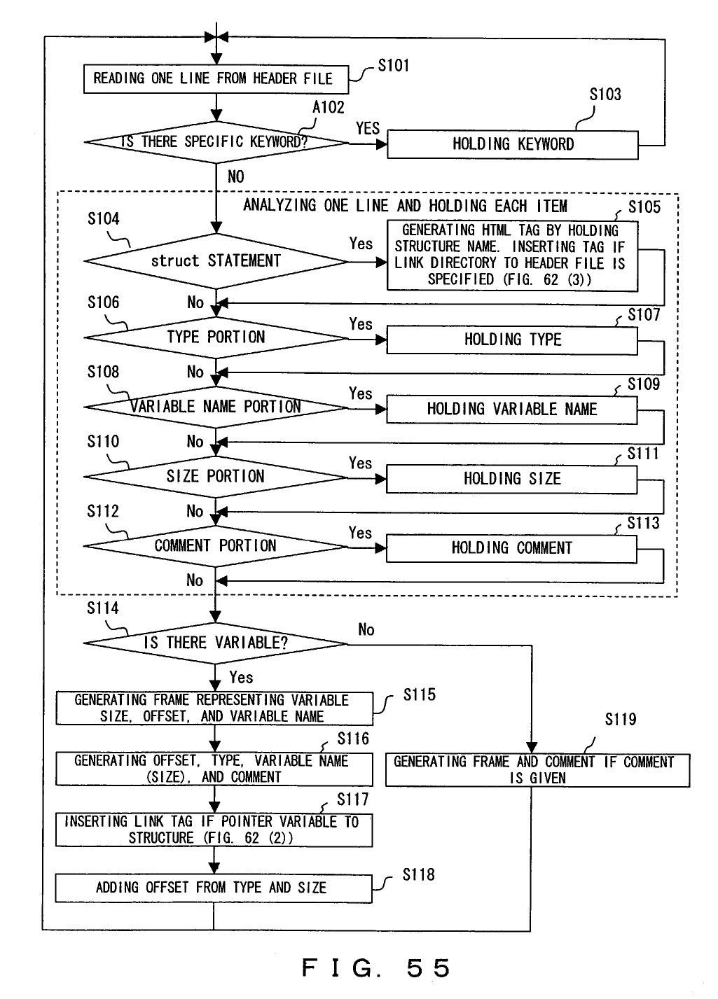

FIG. 55 is a detailed flowchart of the table structure diagram generating process generated in step S95 shown in FIG. 54. When the process starts as shown in FIG. 55, one line is read from the header file first in step S101, it is determined in step S102 whether or not there is a specific keyword, the keyword is held in step S103 if there is the keyword, and the processes in and after step S101 are repeated. An example of the specific keyword is described later.

If there is no specific keyword in step S102, then the read line is analyzed in steps S104 through S113, and the process of holding each item in the line is performed. If it is a struct statement in step S104, then in step S105, a structure name is held, an HTML tag is generated, and a tag is inserted if a link directory to the header file is specified.

If it is a type in step S106, then the type is held in step S107. If it is a variable name in step S108, then the variable name is held in step S109. If it is a size in step S110, then the size is held in step S111. If it is a comment in step S112, then the comment is held in step S113.

Then, it is determined in step S114 whether or not there is a variable. If there is, the frames representing a size, offset, and variable name of the variable are generated in step S115. In step S116, an offset, type, variable name (size), comment are generated. If it is a pointer variable to a structure in step S117, then a link tag is inserted, an offset is added based on the type and size in step S118, and then the processes in and after step S101 are repeated. If there is no variable in step S114, and if there is a comment in step S119, then the frame and comment are generated in step S119, and then the processes in and after step S101 are repeated.

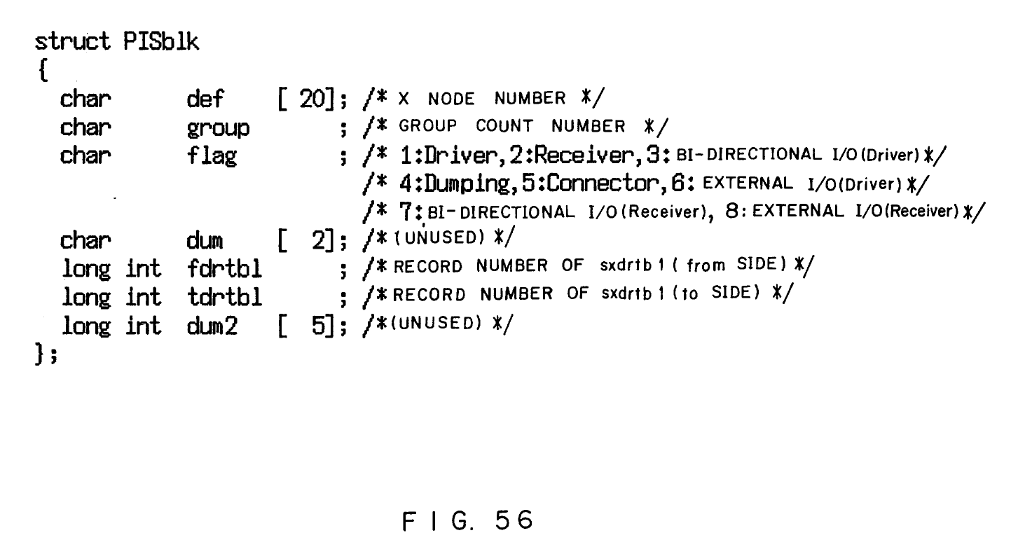

FIGS. 56 through 64 show practical examples of the processes described above by referring to FIG. 55. First, FIG. 56 show an example of the contents of a header file from which the contents are read line by line in step S101 as shown in FIG. 55, and the processes in and after step S102 are performed.

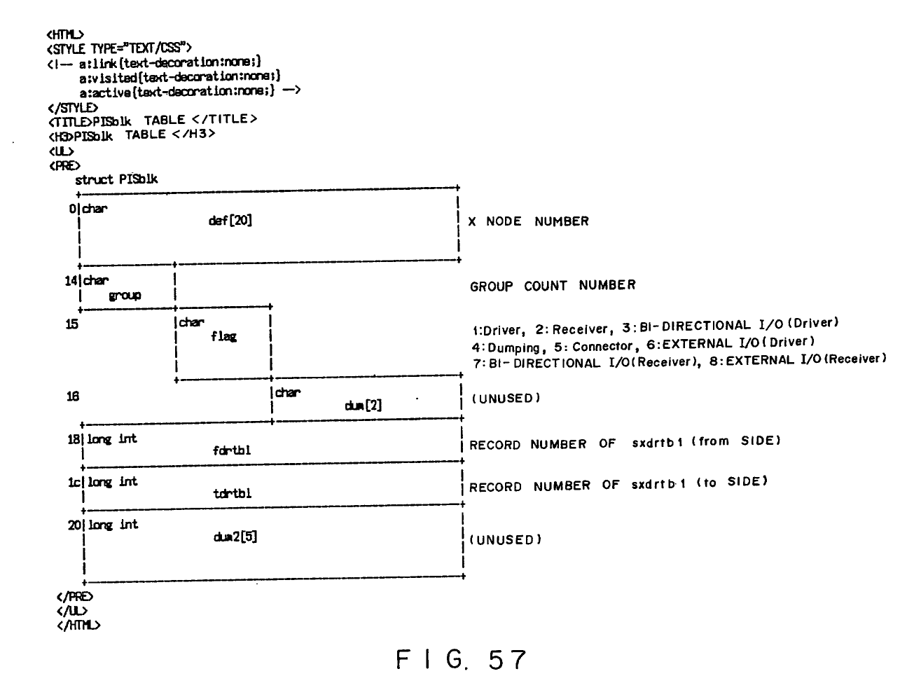

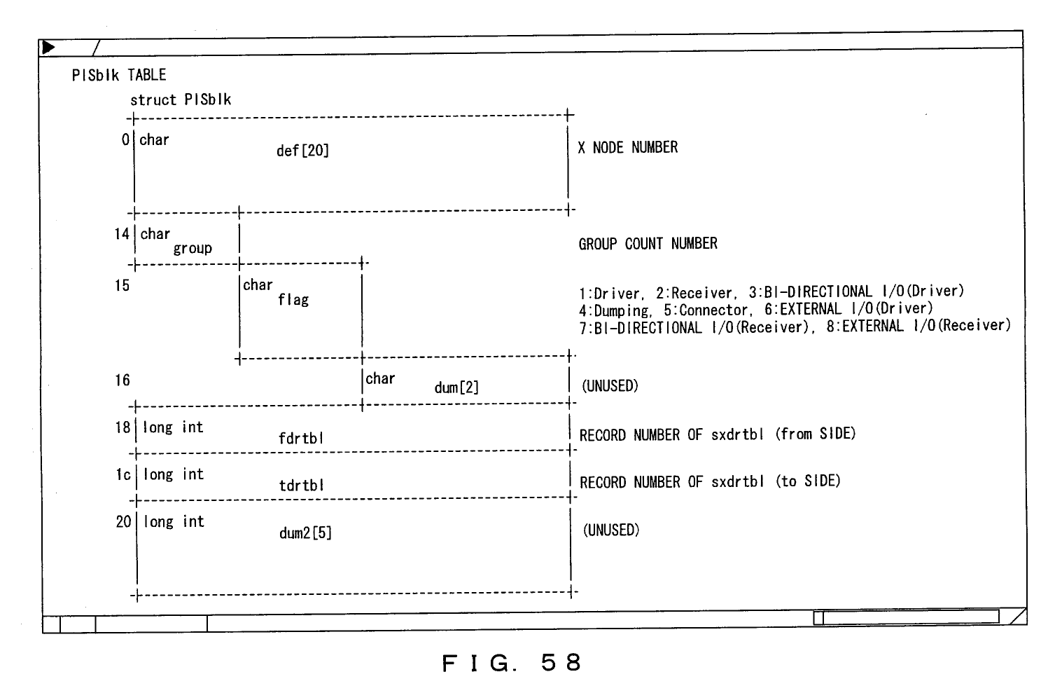

FIG. 57 shows an HTML document indicating a table structure diagram generated from the header file shown in FIG. 56. FIG. 58 shows a result of displaying the HTML document through the WWW browser.

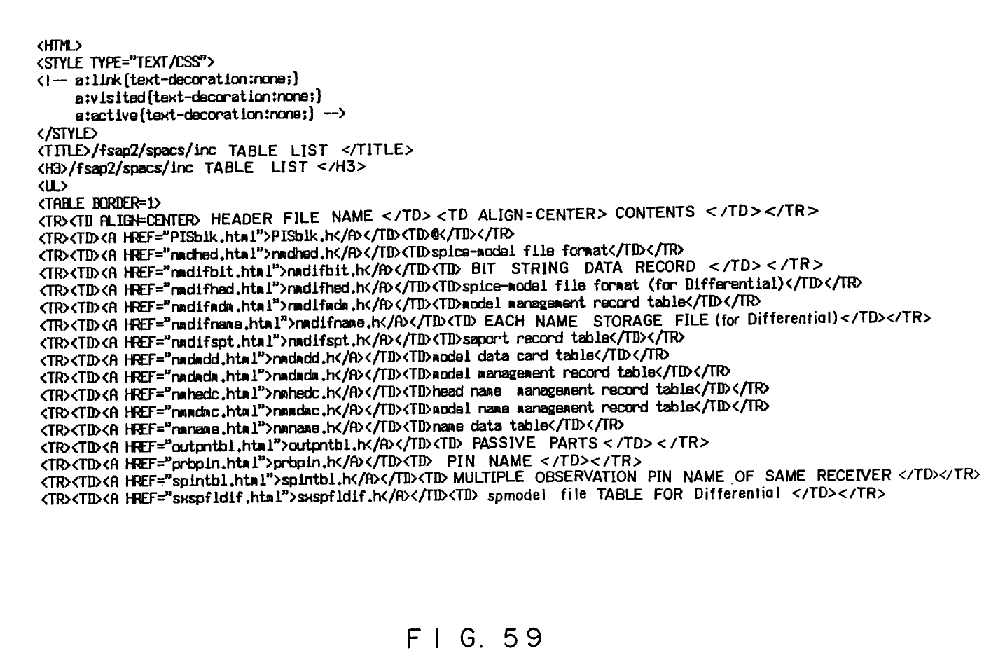

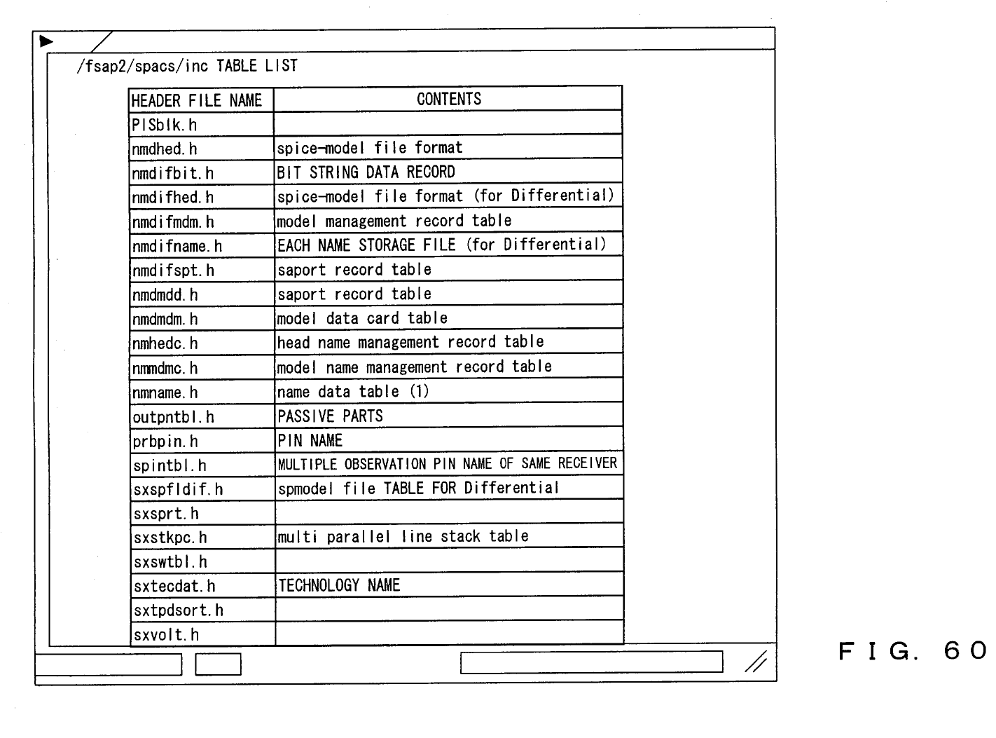

FIG. 59 shows an example of an HTML document indicating a list of table structure diagrams in step S97 shown in FIG. 54. FIG. 60 shows the result of displaying the HTML document through the WWW browser.

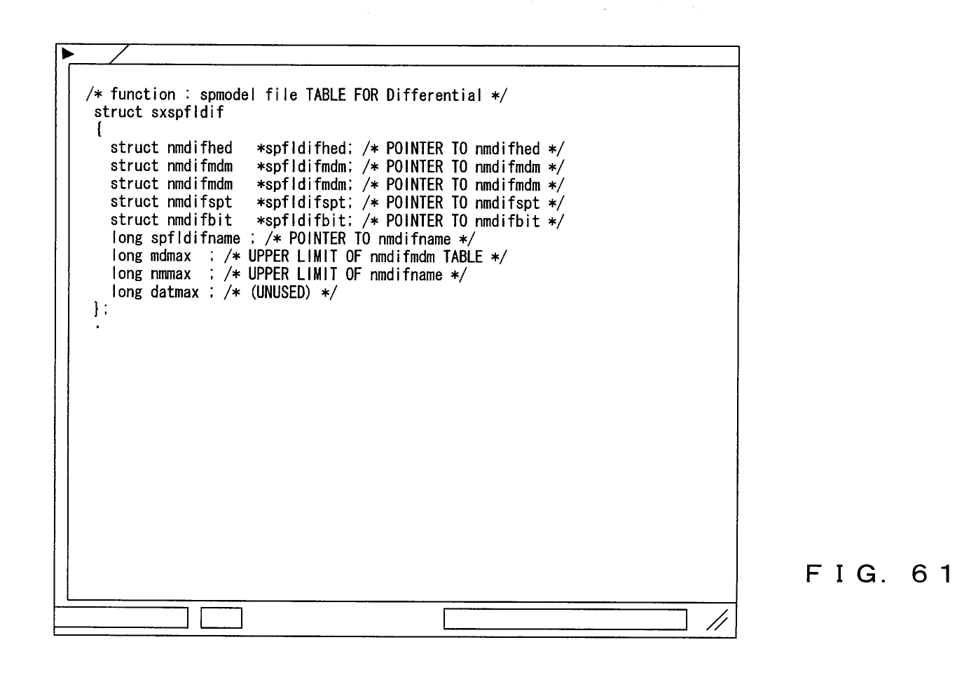

FIGS. 61 through 63 show the relationship between the tags, etc. inserted in the process shown in FIG. 55 and the examples of the screen display, etc. As shown in FIG. 61, as described in step S102 shown in FIG. 55, a specific keyword, for example, if “function” is described, the contents are displayed in a table structure diagram or a table list.

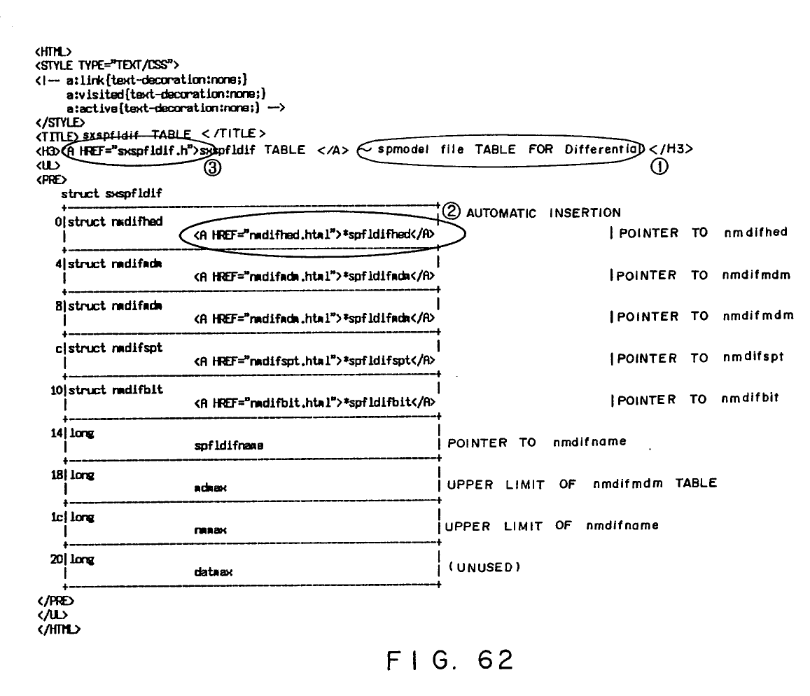

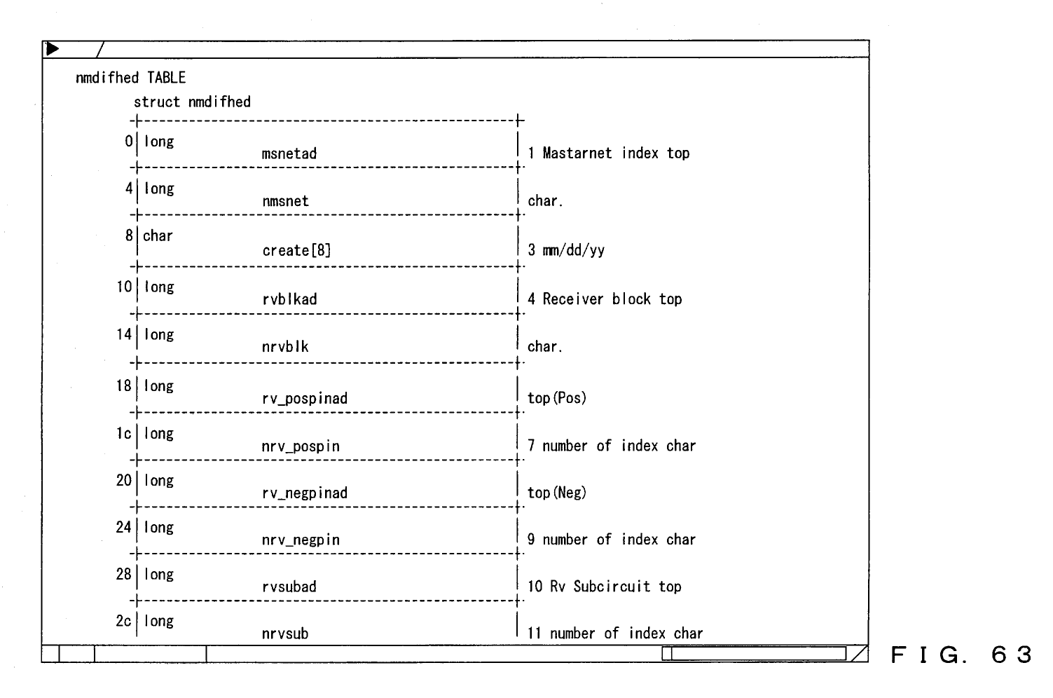

\mathring{1} in FIG. 62 shows an example of the contents of the header file described in the table structure diagram. \mathring{2} in FIG. 62 shows an anchor (statement) (A HREF) corresponding to a link tag in the process described in step S117 shown in FIG. 55. The anchor statement enables another table shown in FIG. 63 to be displayed

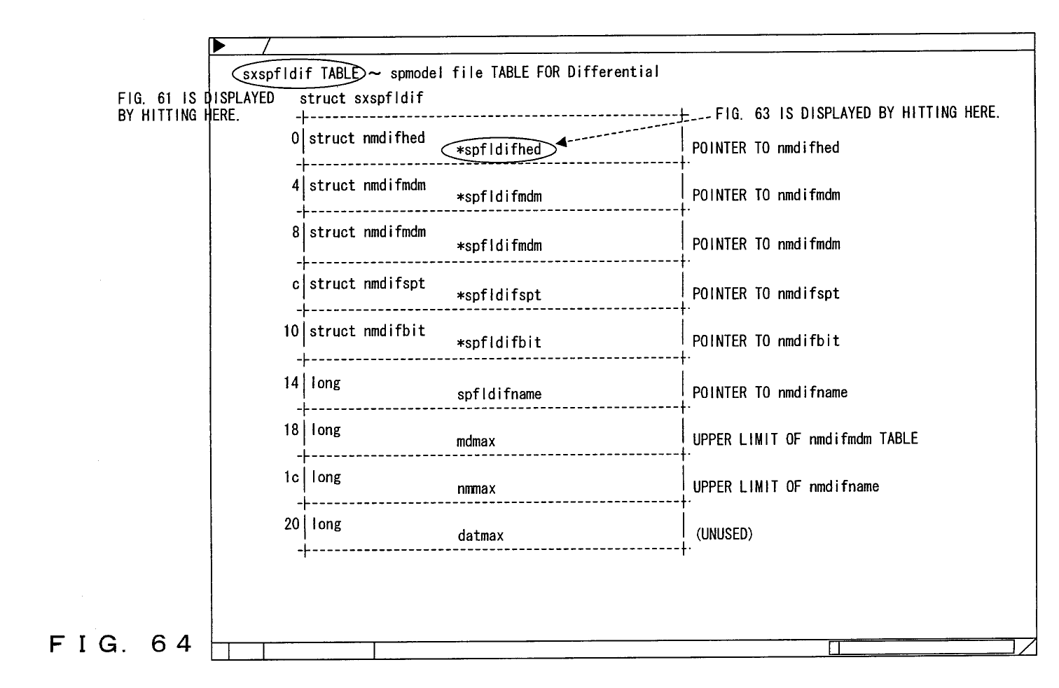

\mathring{1} in FIG. 62 shows an anchor statement as a tag inserted in the process described in step S105 shown in FIG. 55. Thus, as a result of displaying the table structure diagram shown in FIG. 62 through the WWW browser, the title portion of the table name is clicked in FIG. 64, thereby displaying FIG. 61 showing the contents of the header file. By clicking the “spfldifhed” in the table shown in FIG. 64, “a pointer to nmdifhed” is used, and the example shown in FIG. 63 is displayed.

As described above, according to the present invention, the link relation among a plurality of modules forming a program can be analyzed from an object file, and can be displayed as a module link structure diagram on the display screen. The user can process and edit the link structure diagram into a comprehensible diagram on the screen, and segment and display a new structure diagram with attention to an arbitrary module, thereby easily analyzing the program.

Furthermore, the function of generating a WWW document as a combination of an HTML document and a graphic file can be provided for the module link structure diagram displayed on the screen, and an anchor tag of the HTML language is inserted among a plurality of module link structure diagrams, thereby freely referring to the module link structure diagrams through the WWW browser, and quickly and flexibly grasping the module configuration.

Additionally, the structure diagram of an internal table can be generated in the HTML language from a header file, and the table can be referred to using the WWW browser. When there is a link among a plurality of tables, an anchor tag can be inserted into them for cross-reference among the tables, thereby improving the analysis efficiency of a program and the efficiency of a fault check.

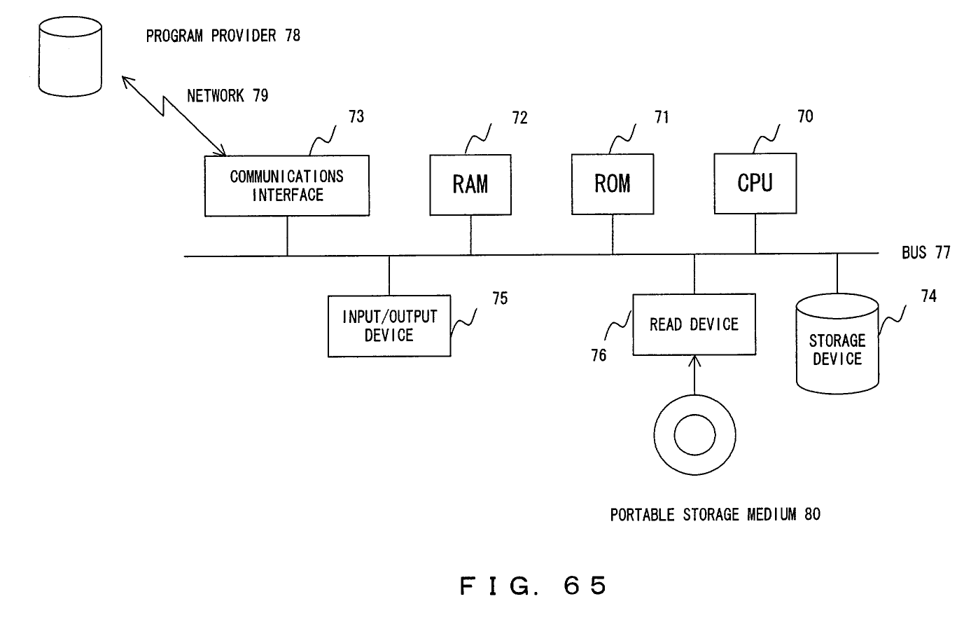

Thus, the software maintenance material generation apparatus and a generation program therefor according to the present invention have been described above, but the maintenance material generation apparatus can be configured as a common computer system. FIG. 65 is a block diagram of the configuration of the computer system, that is, a hardware environment.

In FIG. 65, the computer system comprises a central processing unit (CPU) 70, read-only memory (ROM) 71, random access memory (RAM) 72, a communications interface 73, a storage device 74, an input/output device 75, a read device 76 of a portable storage medium, and a bus 77 for connection of these components.

The storage device 74 can be various types of storage devices such as a hard disk, a magnetic disk, etc. These storage device 74 and ROM 71 store the programs shown in the flowcharts in FIGS. 4 through 6, 18 through 20, 23, 31, 42, 43, 47, 48, 54, 55, etc. and the programs according to claims 17 and 19 of the present invention. These programs are executed by the CPU 70 to display, process, and edit the module link structure diagram according to the present embodiment, and generate an internal table structure diagram, etc. of a header file.

These programs can be stored in the storage device 74 from a program provider 78 through a network 79 and the communications interface 73, or can be marketed, stored in a commonly distributed portable storage medium 80, set in the read device 76, and executed by the CPU 70. The portable storage medium 80 can be various storage media such as CD-ROM, a flexible disk, an optical disk, a magneto-optic disk, etc., and a program stored in these storage media is read by the read device 76, thereby displaying a module link structure diagram, etc. according to the present embodiment.

As described above, according to the present invention, a link structure of a module in a program can be analyzed from one or more objects of a program, and a link structure diagram can be automatically displayed on the screen. Thus, first, the module link structure diagram can be easily edited and processed, and the program can be easily analyzed.

Second, the generated module link structure diagram can be converted into an HTML document and can be referred to through a WWW tool, and a part of the complicated module link structure diagram can be segmented and checked in detail.

Third, using the WWW tool, the contents of a source file can be accessed, and the module structure diagram and the source file can be alternately referred to, thereby saving the time and cost for analysis of the program.

Then, the table structure diagram of an internal table and a list of tables can be generated from the header file as a HTML document, referred to by the WWW tool, and an inserted tag can be traced on the table structure diagram using an inserted tag, thereby saving time and cost for program analysis.

Using the function of automatically analyzing the module link structure and generating a structure diagram according to the present invention, the latest state of a program can be constantly obtained by displaying the module link structure diagram on the screen only by updating the header file and the source file, thereby largely improving the maintenance efficiency of the program.

What is claimed is:

1. A software maintenance material generation apparatus having a plurality of modules as components, comprising:
a link relation analysis unit analyzing link relation among the plurality of modules from one or more objects corresponding to software; and
a link relation storage unit storing an analysis result of said link relation analysis unit.

2. The apparatus according to claim 1, further comprising:
a link structure diagram display unit displaying the analysis result of said link relation analysis unit as a module link structure diagram.

3. The apparatus according to claim 2, further comprising:
a link structure diagram edit unit externally receiving an instruction to change a display style for the module link structure diagram displayed by said link structure diagram display unit, and controlling the change of the display style.

4. The apparatus according to claim 3, wherein
said link structure diagram edit unit controls the change of the display style to the module link structure diagram including as a leading module a module specified in the displayed module link structure diagram in response to the externally received instruction.

5. The apparatus according to claim 3, wherein
said link structure diagram edit unit controls the change of the display style to the module link structure diagram including as a trailing module a module specified in the displayed module link structure diagram in response to the externally received instruction.

6. The apparatus according to claim 3, wherein
said link structure diagram edit unit controls the change of the display style to the module link structure diagram including a module specified in the displayed module link structure diagram as located substantially in a center on a display screen in response to the externally received instruction.

7. The apparatus according to claim 3, wherein
said link structure diagram edit unit controls the change of the display style by displaying or not displaying a module lower than a module specified in the displayed module link structure diagram in response to the externally received instruction.

8. The apparatus according to claim 2, further comprising
a document generation unit generating a document corresponding to a module link structure diagram displayed by said link structure diagram display unit.

9. The apparatus according to claim 8, wherein
said document generation unit inserts a link specifying a directory of a source file of software into the document corresponding to a module in the module link structure diagram.

10. The apparatus according to claim 8, wherein
said document generation unit inserts a link specifying a different module link structure diagram into the document corresponding to a module in the module link structure diagram.

11. The apparatus according to claim 8, further comprising
a specification generation unit generating module specifications from a source file, wherein
said document generation unit inserts a link to the module specifications into the document corresponding to a specific keyword in the document.

12. A software maintenance material generation apparatus having contents of one or more header files as components, comprising
a table specification generation unit generating, from the one or more header files, specifications of each table in one or more header files.

13. The apparatus according to claim 12, further comprising
a table list generation unit generating a list of a table whose specifications have been generated by said table specification generation unit.

14. The apparatus according to claim 13, wherein
said table list generation unit inserts a link into a table list to display a specific table when the table is externally specified after displaying the table list.

15. The apparatus according to claim 12, wherein
when there is a pointer in the internal table to another table, said table specification generation unit inserts a link to the other table into the table.

16. The apparatus according to claim 12, wherein
said table specification generation unit inserts a link to the header file into the table specifications.

17. A program used by a computer generating a software maintenance material formed by a plurality of modules, comprising:
analyzing link relation among the plurality of modules from one or more objects corresponding to software; and
storing an analysis result of the link relation in memory.

18. A computer-readable storage medium storing a program executed by a computer which generates a software maintenance material formed by a plurality of modules, comprising the steps of:
analyzing link relation among the plurality of modules from one or more objects corresponding to software; and
storing an analysis result of the link relation in memory.

19. A program used by a computer which generates a software maintenance material having contents of one or more header files as components, comprising:
generating specifications of each internal table from the one or more header files; and
generating a list of each table whose specifications have been generated.

20. A computer-readable storage medium used by a computer which generates a software maintenance material having contents of one or more header files as components, comprising the steps of:
generating specifications of each internal table from the one or more header files; and
generating a list of each table whose specifications have been generated.

21. A software maintenance material generation apparatus having a plurality of modules as components, comprising:
link relation analysis means for analyzing link relation among the plurality of modules from one or more objects corresponding to software; and
link relation storage means for storing an analysis result of said link relation analysis means.

22. The apparatus according to claim 21, further comprising:
link structure diagram display means for displaying the analysis result of said link relation analysis means as a module link structure diagram.

23. A software maintenance material generation apparatus having contents of one or more header files as components, comprising:
table specification generation means for generating, from the one or more header files,
specifications of each table in one or more header files; and
table list generation means for generating a list of each table whose specifications have been generated.
